(19) United States
(12) Patent Application Publication
(10) Pub. No.: US 2023/0315719 A1
(43) Pub. Date: Oct. 5, 2023

(54) DATA TRANSFER DEVICE, DATA TRANSFER METHOD AND NON-TRANSITORY COMPUTER READABLE MEDIUM

(71) Applicant: MITSUBISHI ELECTRIC CORPORATION, Tokyo (JP)

(72) Inventor: Masaya HONJO, Tokyo (JP)

(73) Assignee: MITSUBISHI ELECTRIC CORPORATION, Tokyo (JP)

(21) Appl. No.: 18/205,838

(22) Filed: Jun. 5, 2023

Related U.S. Application Data
(63) Continuation of application No. PCT/JP2021/003833, filed on Feb. 3, 2021.

(51) Int. Cl. G06F 16/23

(52) U.S. Cl. CPC G06F 16/2379

(57) ABSTRACT

A data transfer device (1) includes a data acquisition unit (112), a data selection unit (113) and a transfer order creation unit (12). The data acquisition unit (112) acquires, based on a transfer request to transfer electronic data from a transfer-source distributed ledger to a transfer-destination distributed ledger, acquisition data including data corresponding to the transfer request, and corresponding to each of creation elements, each of the creation elements respectively created as each element of transfer data being data including one or more elements, from the transfer-source distributed ledger. The data selection unit (113) selects and extracts data corresponding to the creation elements from the acquisition data. The transfer order creation unit (12) creates a transfer order to transfer the data corresponding to each of the creation elements to the transfer-destination distributed ledger, using the data corresponding to the creation elements.

### CROSS REFERENCE TO RELATED APPLICATIONS

This application is a continuation of PCT International Application No. PCT/JP2021/003833, filed on Feb. 3, 2021, all of which is hereby expressly incorporated by reference into the present application.

### TECHNICAL FIELD

The present invention relates to a data transfer device, a data transfer method and a data transfer program.

### BACKGROUND ART

Systems utilizing distributed ledgers represented by a blockchain have been increased. The distributed ledger is a technique to share a transaction being an operation request of a ledger between stakeholders, and to realize a shared ledger between the stakeholders. As for a general distributed ledger, a node being a distributed ledger server owned by each stakeholder retains all the past transactions of at least the node and the stakeholders relevant to the node; hence, it is possible to verify shared data including past data between the stakeholders. Therefore, the distributed ledger is effective as a means to secure verifiability of shared data.

In a system utilizing the distributed ledger, when a distributed ledger during operation (transfer-source distributed ledger) is replaced with a distributed ledger (transfer-destination distributed ledger) being a new environment due to reasons such as update or transfer, etc. of the system, there is a necessity to transfer at least a part of data registered with the transfer-source distributed ledger to the transfer-destination distributed ledger as needed.

Patent Literature 1 discloses a device to perform data transfer by registering data recorded in a transfer-source distributed ledger with a transfer-destination distributed ledger in response to a transaction with respect to an asset recorded in a ledger.

### CITATION LIST

### Patent Literature

Patent Literature 1: JP2020-042671 A

### SUMMARY OF INVENTION

### Technical Problem

The method in Patent Literature 1 is a method to transfer only the latest data value recorded in the ledger to the transfer-destination distributed ledger, wherein transactions in the transfer-source distributed ledger are not transferred. Therefore, according to the method in Patent Literature 1, there is a problem that it is necessary to continue operation of the transfer-source distributed ledger when past transactions are retained.

The present invention is aimed at transferring not only the latest data value recorded in the transfer-source distributed ledger, but also past transactions recorded in the transfer-source distributed ledger, to the transfer-destination distributed ledger, when electronic data is transferred from the transfer-source distributed ledger to the transfer-destination distributed ledger.

### Solution to Problem

There is provided according to one aspect of the present disclosure a data transfer device includes:
a data acquisition unit to acquire, based on a transfer request to transfer electronic data from a transfer-source distributed ledger to a transfer-destination distributed ledger, acquisition data including data corresponding to each of creation elements, each of the creation elements respectively created as each element of transfer data being data including one or more elements, from the transfer-source distributed ledger;
a data selection unit to select and extract data corresponding to the creation elements from the acquisition data: and
a transfer order creation unit to create a transfer order to transfer the data corresponding to each of the creation elements to the transfer-destination distributed ledger, using the data corresponding to the creation elements, wherein
the transfer data is data corresponding to the transfer request, and
each of the creation elements corresponds to at least a part of the electronic data.

### Advantageous Effects of Invention

A data acquisition unit acquires acquisition data from a transfer-source distributed ledger, a data selection unit extracts data corresponding to creation elements from the acquisition data, and a transfer order creation unit determines a transfer order of each of the creation elements created as each element of transfer data. Therefore, in a case wherein when the data corresponding to the creation elements includes past transactions recorded in the transfer-source distributed ledger, the transfer order creation unit determines an order to transfer the data including the transactions. Further, the acquisition data may include the latest data value recorded in the transfer-source distributed ledger.

Therefore, according to the present embodiment, in a case wherein electronic data is transferred from the transfer-source distributed ledger to the transfer-destination distributed ledger, it is possible to transfer not only the latest data value recorded in the transfer-source distributed ledger, but also the past transactions recorded in the transfer-source distributed ledger.

### BRIEF DESCRIPTION OF DRAWINGS

FIG. 1 is a diagram illustrating a configuration example of a data transfer system 90 according to a first embodiment;

FIG. 2 is a diagram illustrating a configuration example of hardware of each device included in the data transfer system 90 according to the first embodiment;

FIG. 3 is a diagram illustrating a configuration example of software of each device included in the data transfer system 90 according to the first embodiment;

FIG. 4 is a flowchart illustrating an operation of the data transfer system 90 according to the first embodiment;

FIG. 5 is a diagram illustrating a specific example of a transfer-source data acquisition request 501 according to the first embodiment;

FIG. 6 is a specific example of selected transaction data 502 according to the first embodiment;

FIG. 7 is a diagram illustrating a specific example of supplementary data 503 according to the first embodiment;

FIG. 8 is a diagram illustrating a specific example of a transaction relation graph 504, vertex data 505 and edge data 506 according to the first embodiment;

FIG. 9 is a diagram illustrating a specific example of a main key update history table 507 and a smart contract update history table 508 according to the first embodiment;

FIG. 10 is a flowchart illustrating an operation of a transaction-relation data creation unit 121 according to the first embodiment;

FIG. 11 is a flowchart illustrating an operation of the transaction-relation data creation unit 121 according to the first embodiment;

FIG. 12 is a diagram illustrating a specific example of a transaction-destination data registration request 509 according to the first embodiment;

FIG. 13 is a diagram illustrating a specific example of transfer data 510 according to the first embodiment:

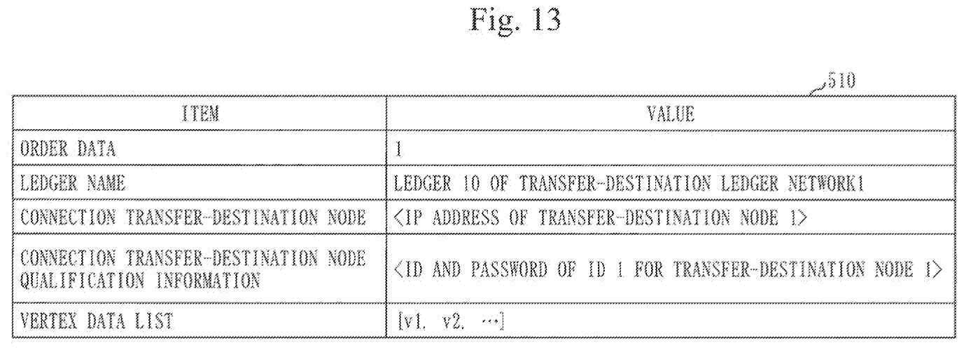

FIG. 14 is a flowchart illustrating an operation of a data creation unit 132 according to the first embodiment;

FIG. 15 is a flowchart illustrating an operation of a data transmission unit 133 according to the first embodiment;

FIG. 16 is a diagram illustrating a configuration example of hardware of the data transfer device 1 according to a variation of the first embodiment;

FIG. 17 is a diagram illustrating a configuration example of the data transfer system 90 according to a second embodiment;

FIG. 18 is a diagram illustrating a configuration example of hardware of each device included in the data transfer system 90 according to the second embodiment;

FIG. 19 is a diagram illustrating a configuration example of software of each device included in the data transfer system 90 according to the second embodiment;

FIG. 20 is a flowchart illustrating an operation of the data transfer system 90 according to the second embodiment:

FIG. 21 is a diagram illustrating a specific example of a transfer-destination data registration request 509b according to the second embodiment;

FIG. 22 is a flowchart illustrating an operation of the data creation unit 132 according to the second embodiment;

FIG. 23 is a flowchart illustrating an operation of the data creation unit 132 according to the second embodiment;

FIG. 24 is a flowchart illustrating an operation of the data transmission unit 133 according to the second embodiment:

FIG. 25 is a diagram illustrating a configuration example of the data transfer system 90 according to a third embodiment;

FIG. 26 is a diagram illustrating a configuration example of software of each device included in the data transfer system 90 according to the third embodiment;

FIG. 27 is a flowchart illustrating an operation of the data transfer system 90 according to the third embodiment;

FIG. 28 is a diagram illustrating a specific example of a data verification request 511 according to the third embodiment:

FIG. 29 is a flowchart illustrating an operation of a verification unit 163 according to the third embodiment;

FIG. 30 is a flowchart illustrating an operation of the verification unit 163 diagram according to the third embodiment:

FIG. 31 is a diagram illustrating a configuration example of the data transfer system 90 according to a fourth embodiment:

FIG. 32 is a diagram illustrating a configuration example of hardware of each device included in the data transfer system 90 according to the fourth embodiment;

FIG. 33 is a diagram illustrating a configuration example of software of each device included in the data transfer system 90 according to the fourth embodiment;

FIG. 34 is a flowchart illustrating an operation of a data acquisition unit 112 according to the fourth embodiment; and

FIG. 35 is a flowchart illustrating an operation of the data transmission unit 133 according to the fourth embodiment.

### DESCRIPTION OF EMBODIMENTS

In description and drawings of the embodiment, the same elements and the corresponding elements are denoted by the same reference signs. Description of an element denoted by the same reference sign will be appropriately omitted or simplified. Arrows in the drawings mainly express data flows or process flows. Further. “unit” may be replaced with “circuit”, “step”, “procedure,” “processing” or “circuitry”.

### First Embodiment

Hereinafter, the present embodiment will be described in detail with reference to diagrams.

***Explanation of Configuration***

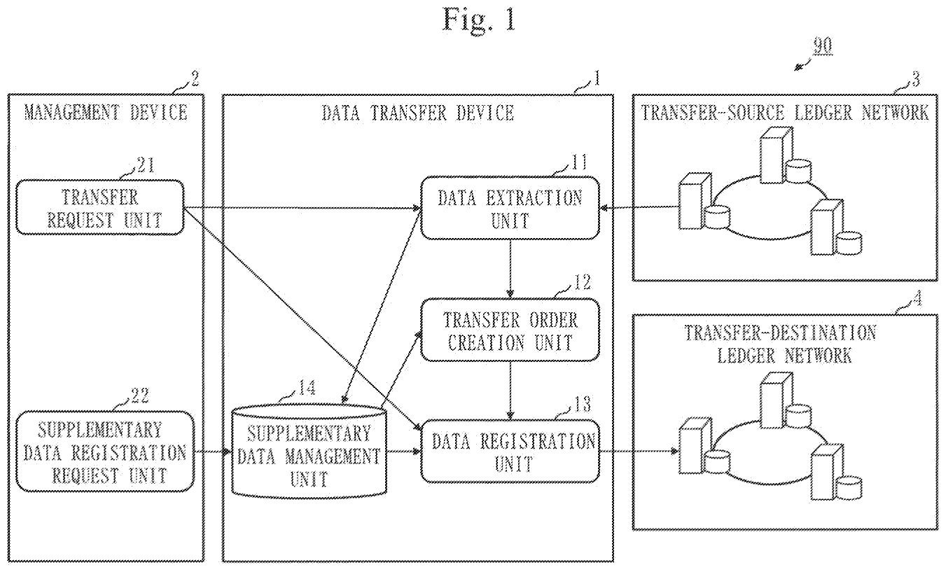

FIG. 1 illustrates a configuration example of the data transfer system 90 according to the present embodiment. The data transfer system 90 includes, as illustrated in the present diagram, a data transfer device 1, a management device 2, a transfer-source ledger network 3 and a transfer-destination ledger network 4. The data transfer device 1 is also called a data extraction/transfer device. The transfer-source ledger network 3 is also called a transfer-source distributed ledger network. The transfer-destination ledger network 4 is also called a transfer-destination distributed ledger network.

The data transfer device 1 receives a transfer request from the management device 2, extracts based on the transfer request a transaction and supplementary data 503 appropriately from the transfer-source ledger network 3, and transfers the transaction and the supplementary data 503 extracted to the transfer-destination ledger network 4. The transfer “request” is a request to transfer electronic data from the transfer-source distributed ledger to the transfer-destination distributed ledger. The term request may indicate information including contents of instructions. The data transfer device 1 may be an application. The application may be called an application program. The term “device” may be used as a general term of a device and an application. The device may not be limited to a physical thing, but may be a virtual thing generated by a virtualization technology.

It is possible for the data transfer device 1 to mutually communicate with the management device 2, at least one transfer-source node 31 of the transfer-source ledger network 3, and at least one transfer-destination node 41 of the transfer-destination ledger network 4.

The management device 2 is a device or an application having a function to transmit the transfer request and the supplementary data 503 to the data transfer device 1. The management device 2 may be called a management application. The supplementary data 503 is data used at the time when the data transfer device 1 creates a transaction to the transfer-destination ledger network 4.

The transfer-source ledger network 3 is a distributed ledger network in operation, which records a transfer transaction. The transfer transaction is a transaction to be transferred. The transfer-source ledger network 3 is constituted by one or more transfer-source nodes 31. The transfer-source node 31 is a device or an application to record the transfer-source distributed ledger.

The transfer-destination ledger network 4 is a distributed ledger network being a transfer destination of the transfer transaction. The transfer-destination network 4 is constituted by one or more transfer-destination nodes 41. The transfer-destination node 41 is a device or an application to record the transfer-destination distributed ledger.

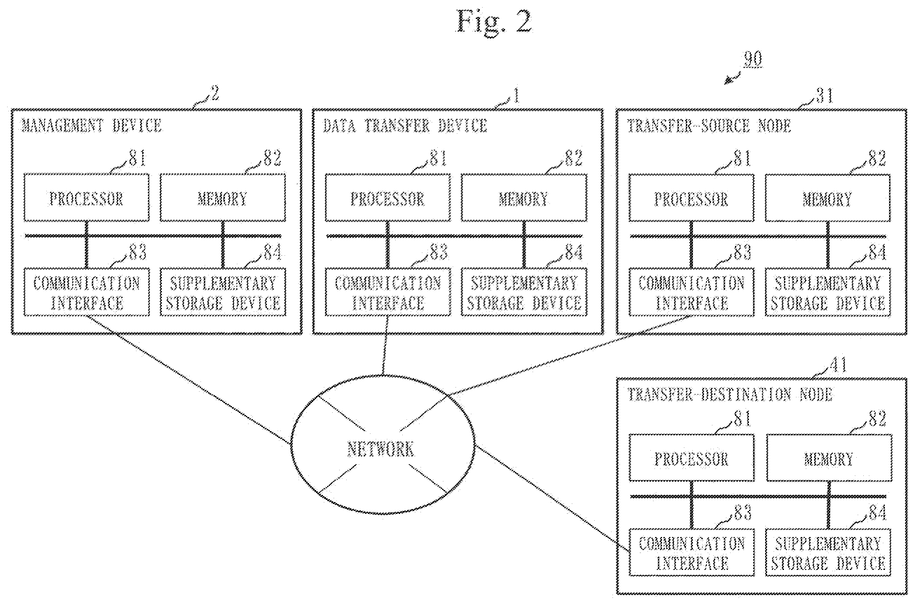

FIG. 2 illustrates a configuration example of hardware of each device included in the data transfer system 90. The present diagram illustrates a specified example of a case wherein each of the data transfer device 1, the management device 2, the transfer-source node 31 and the transfer-destination node 41 operates in an independent device. Each device is a computer including hardware components such as a processor 81, a memory 82, an auxiliary storage device 84 and a communication interface 83, etc. These hardware components are connected appropriately via a signal line. Each device is connected via one network. The number of network included in the data transfer system 90 may not be one, and the data transfer system 90 may include a plurality of networks only if it is possible to perform communication between each of the data transfer device 1 and the management device 2, of the data transfer device 1 and at least one transfer-source node 31 of the transfer-source ledger network 3, and of the data transfer device 1 and at least one transfer-destination node 41 of the transfer-destination ledger network 4. Further, at least a part of the data transfer device 1, the management device 2, the transfer-source node 31 and the transfer-destination node 41 may be constituted by a same device. The nodes are also devices.

The processor 81 is an IC (integrated circuit) to perform arithmetic processing, which controls hardware components included in a computer. The processor 81 is, for example, a CPU (central processing unit), a DSP (digital signal processor) or a GPU (graphics processing unit).

Each device included in the data transfer system 90 may include a plurality of processors to replace the processor 81. The plurality of processors share the role of the processor 81.

The memory 82 is typically a volatile storage device. The memory 82 may be called a main storage device or a main memory. The memory 82 is, for example, a RAM (random access memory). The data stored in the memory 82 is stored in the auxiliary storage device 84 as needed.

The communication interface 83 is a receiver or a transmitter. The communication interface 83 is, for example, a communication chip or an NIC (network interface card). Each unit of each device included in the data transfer system 90 uses the communication interface 83 appropriately in communicating with other devices, etc.

The auxiliary storage device 84 is typically a non-volatile storage device. The auxiliary storage device 84 is, for example, a ROM (read only memory), an HDD (hard disk drive) or a flash memory. The data stored in the auxiliary storage device 84 is loaded into the memory 82 as needed.

The auxiliary storage device 84 stores a data transfer program. The data transfer program is a program to make a computer realize functions of each unit included in the data transfer device 1. The data transfer program is loaded into the memory 82, and executed by the processor 81. The functions of each unit of each device included in the data transfer system are realized by software.

Each unit of each device included in the data transfer system 90 uses a storage device appropriately. The storage device is, for example, constituted by at least one of the memory 82, the auxiliary storage device 84, a register in the processor 81, and a cache memory in the processor 81. Data and information may be equivalent in meaning. The storage device may be independent from the computer 10.

The functions of the memory 82 and the auxiliary storage device 84 may be realized by another storage device.

The programs that run on any devices described in the present specification may be recorded on a computer-readable non-volatile recording medium. A specific example of the non-volatile recording medium is an optical disk or a flash memory. The programs that run on any devices described in the present specification may be provided in the form of a program product.

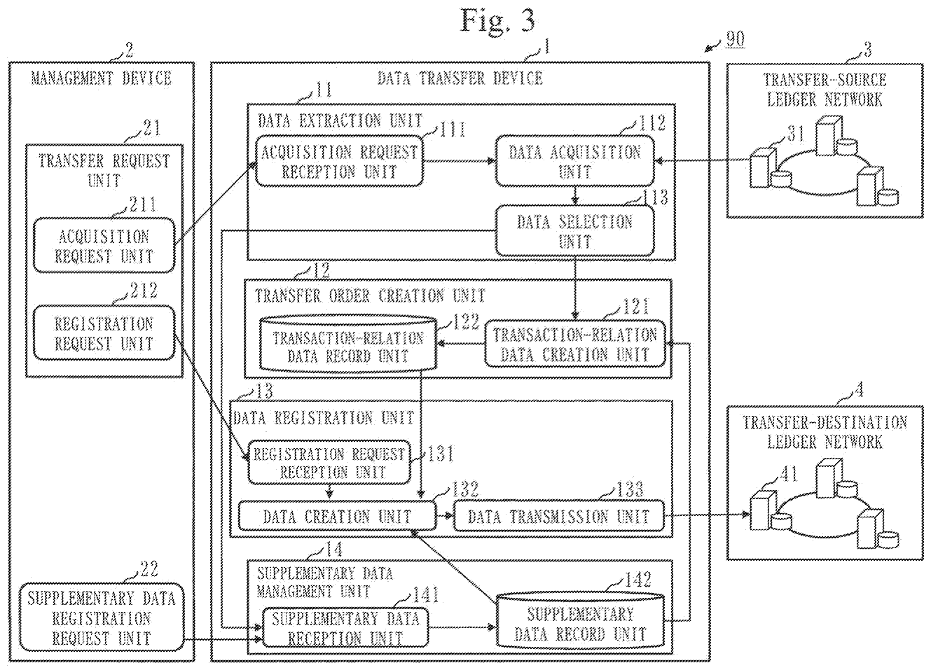

FIG. 3 illustrates a configuration example of software of each device included in the data transfer system 90. In the example, it is supposed that a delegate having a privilege to access to at least one transfer-source node 31 and at least one transfer-destination 41 transfers all data. The delegate may be a computer or the like.

The data transfer device 1 includes a data extraction unit 11, a transfer order creation unit 12, a data registration unit 13 and a supplementary data management unit 14.

The data extraction unit 11 includes an acquisition request reception unit 111, a data acquisition unit 112 and a data selection unit 113.

The acquisition request reception unit 111 receives, from the management device 2, an acquisition request to request acquisition of a transaction of the transfer-source ledger network 3 and supplementary data 503 related to the transaction from the transfer-source distributed ledger.

The data acquisition unit 112 acquires data including the transaction and the supplementary data 503 related to the transaction from the transfer-source ledger network 3, as acquisition data. The data acquisition unit 112 acquires the acquisition data from the transfer-source distributed ledger based on the transfer request. Acquisition of data from the transfer-source distributed ledger is realized by receiving the data from the transfer-source node 31 which records the transfer-source distributed ledger. The acquisition data includes data corresponding to each of creation elements, each of the creation elements respectively created as each element of transfer data 510 to be described below. The expression “creation element” is an expression to explain an element that has not been created as an element of the transfer data 510. The transfer data 510 is data including one or more elements, data corresponding to the transfer request, and data indicating at least a part of electronic data which is recorded in the transfer-source distributed ledger. As a specific example, each element of the transfer data 510 is data indicating vertex data 505 to be described below. The data corresponding to the creation element is, for example, selected transaction data 502 corresponding to a transaction ID indicated by the vertex data 505 corresponding to a vertex ID being a creation element. That is, each of the creation elements corresponds to at least a part of electronic data to be transferred from the transfer-source distributed ledger to the transfer-destination distributed ledger. The supplementary data 503 is at least one piece of data corresponding to at least one piece of data corresponding to the creation elements on a one-to-one basis, and is data to support transferring data corresponding to each creation element to the transfer-destination distributed ledger.

The data selection unit 113 extracts data corresponding to data which should be included in the transfer data 510 by selecting acquisition data, and further, in a case wherein the acquisition data includes data which should be included in the supplementary data 503, extracts the data which should be included in the supplementary data 503. The data selection unit 113 selects and extracts data corresponding to the creation elements from the acquisition data. The data selection unit 113 may extract the data corresponding to the creation elements from the acquisition data as the selected transaction data 502.

The data selection unit 113 transmits the data corresponding to the data which should be included in the transfer data 510 to a transaction-relation data creation unit 121, and transfers the supplementary data 503 to a supplementary data reception unit 141.

The transfer order creation unit 12 includes the transaction-relation data creation unit 121 and a transaction-relation data record unit 122, the transfer order creation unit 12 being also referred to as a transaction order arrangement unit. The transfer order creation unit 12 creates the transfer order to transfer the data corresponding to each of the creation elements to the transfer-destination distributed ledger using the creation elements. The transfer order creation unit 12 creates, when the supplementary data 503 exists, the transfer order using the data corresponding to the creation elements and the supplementary data 503. The data corresponding to the creation element is, as a specific example, selected transaction data 502, or a set of selected transaction data 502 and supplementary data 503 corresponding to the selected transaction data 502.

The transaction-relation data creation unit 121 creates transaction-relation data to support deriving an efficient order to register transactions with the transfer-destination ledger network 4 based on data extracted by the data selection unit 113, which should be included in data to be transferred to the transfer-destination distributed ledger, and records the transaction-relation data created in the transaction-relation data record unit 122. When the supplementary data 503 does not exist, the transaction-relation data creation unit 121 uses the selected transaction data 502, and creates transaction-relation data based on relations between pieces of the selected transaction data 502. The transaction-relation data is data to specify a transfer order. Further, when the supplementary data 503 exists, the transaction-relation data creation unit 121 creates transaction-relation data using the selected transaction data 502 and the supplementary data 503. The transaction-relation data creation unit 121 may create a transaction-relation graph 504 as the transaction-relation data. The transaction-relation graph 504 represents a transfer order and a transfer condition in a graph structure. The transfer condition is a condition to transfer the selected transaction data 502 to the transfer-destination distributed ledger.

The data registration unit 13 includes a registration request reception unit 131, a data creation unit 132 and a data transmission unit 133.

The registration request reception unit 131 receives a registration request to request registration of data to transfer with the transfer-destination distributed ledger, from the management device 2.

The data creation unit 132 acquires the transaction-relation data recorded in the transaction-relation data record unit 122, and generates a transaction directed at the transfer-destination distributed ledger using data that can be registered with the transfer-destination distributed ledger at the time when generation of a transaction is started. The data creation unit 132 may create each of the creation elements in accordance with the format of each of the creation elements using the data corresponding to the creation element.

When it is necessary to combine data read out from the transaction-relation data record unit 122 and supplementary data 503 corresponding to the data as one transaction at the time of data creation, the data creation unit 132 refers to the corresponding supplementary data 503 from a supplementary data record unit 142, and generates one transaction by combining the data read out from the transaction-relation data record unit 122 and the corresponding supplementary data 503.

Further, at the time of data creation, if it is necessary for the data to be transferred, which is read out from the transaction-relation data record unit 122, to make some data as well act on the transfer-destination distributed network 4 when the transaction created from the data to be transferred is registered with the transfer-destination ledger network 4, the data creation unit 132 refers to the corresponding supplementary data 503 from the supplementary data record unit 142, makes the transaction generated from the data to be transferred and the supplementary data 503 be registered with and act on the transfer-destination ledger network 4 via the data transmission unit 133.

The data creation unit 132 may use the transaction-relation data and create data including data indicating the selected transaction data 502, or data including pieces of data each indicating the selected transaction data 502 and supplementary data 503 corresponding to the selected transaction data 502, as each of the creation elements. The data creation unit 132 may use the graph structure of the transaction-relation graph 504, and extract data corresponding to each creation element which can be registered with the transfer-destination distributed ledger as registrable data.

The data transmission unit 133 transmits the transaction to the transfer-destination ledger network 4. The data transmission unit 133 transmits the data corresponding to each creation element to the transfer-destination distributed ledger based on the transfer order. The data transmission unit 133 may transmit data including the registrable data to the transfer-destination distributed ledger. Transfer of data to the transfer-destination distributed ledger is realized by transferring the data to the transfer-destination node 41 to record the transfer-destination distributed ledger.

The supplementary data management unit 14 includes a supplementary data reception unit 141 and a supplementary data record unit 142.

The supplementary data reception unit 141 receives a supplementary data registration request from at least any of the management device 2 and the data selection unit 113, and when the supplementary data registration request is received, records the supplementary data 503 in the supplementary data record unit 142.

The management device 2 includes a transfer request unit 21 and a supplementary data registration request unit 22.

The transfer request unit 21 includes an acquisition request unit 211 and a registration request unit 212.

The acquisition request unit 211 requests the data transfer device 1 to acquire a transaction and supplementary data 503 related to the transaction from the transfer-source ledger network 3, and to create transaction-relation data.

The registration request unit 212 uses the transaction-relation data created and the supplementary data 503, and requests the data transfer device 1 to register the data transferred to the transfer-destination ledger network 4.

The supplementary data registration request unit 22 requests the data transfer device 1 to register the supplementary data 503 corresponding to the data to be transferred.

The transfer-source node 31 includes a function to transmit data including the transaction and the supplementary data 503 related to the transaction to the data transfer device 1 in response to a data acquisition request from the data transfer device 1.

The transfer-destination node 41 includes a function to register transaction data with a ledger shared in the transfer-destination ledger network 4 in response to a transaction registration request from the data transfer device 1. Further, the transfer-destination node 41 includes at least any of a function to register the supplementary data 503 with, or a function to make the supplementary data 503 act on, the transfer-destination node 41 or the transfer-destination ledger network 4, in response to a request to register the supplementary data 503, or a request to make the supplementary data 503 act on, from the data transfer device 1.

***Description of Operation***

An operation procedure of the data transfer device 1 corresponds to a data transfer method. A program to realize the operation of the data transfer device 1 corresponds to a data transfer program. An operation procedure of the management device 2 corresponds to a management method. A program to realize an operation of the management device 2 corresponds to a management program. An operation procedure of the transfer-source node 31 corresponds to a transfer-source control method. A program to realize an operation of the transfer-source node 31 corresponds to a transfer-source control program. An operation procedure of the transfer-destination node 41 corresponds to a transfer-destination control method. A program to realize an operation of the transfer-destination node 41 corresponds to a transfer-destination control program.

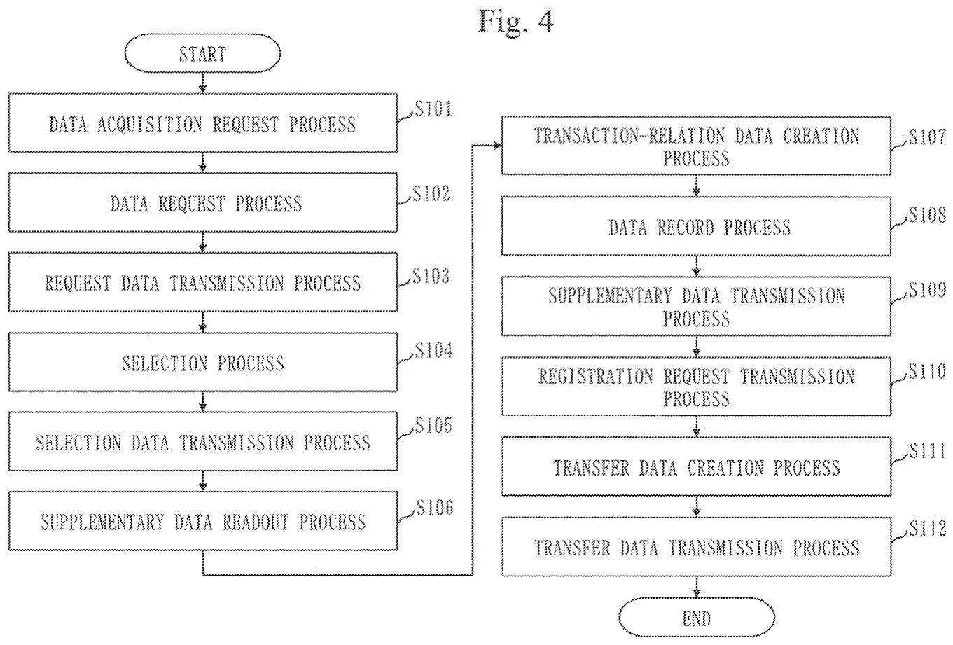

FIG. 4 is a flowchart illustrating an example of an operation of the data transfer system 90. With reference to the present figure, the operation of the data transfer system 90 will be described.

(Step S101: Data Acquisition Request Process)

The acquisition request unit 211 transmits a transfer-source data acquisition request 501 to the data transfer device 1.

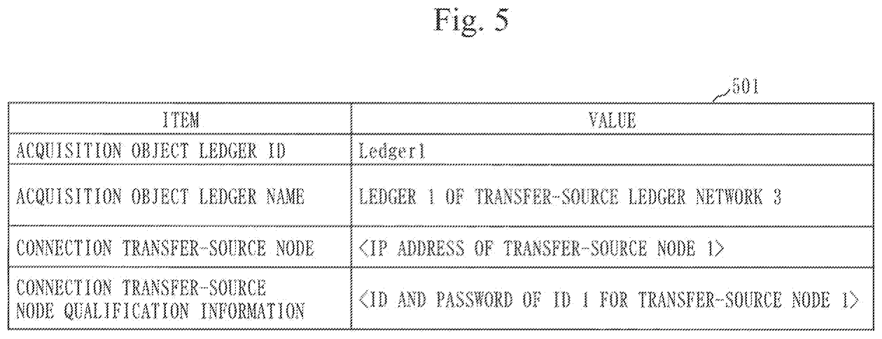

FIG. 5 illustrates an example of the transfer-source data acquisition request 501.

“Acquisition object ledger ID (identification)” is an identifier to uniquely describe a ledger being a data acquisition object. The data acquisition object records transfer-source data.

“Acquisition object ledger name” is a name set to the ledger being the data acquisition object.

“A connection transfer-source node” is information describing a location of the transfer-source node 31 whereto the data acquisition unit 112 connects to acquire data. The connection transfer-source node is the transfer-source node 31 which records data to be transferred. The value of “connection transfer-source node” is, for example, an IP (Internet protocol) address of the transfer-source node 31, or a set of the IP address and a port number of the transfer-source node 31.

“Connection transfer-source node qualification information” is information used when it is necessary to perform authentication in connecting to a connection transfer-source node. “Connection transfer-source node qualification information” needs not exist. The value of “connection transfer-source node qualification information” is, for example, a set of an ID and a password to log into the transfer-source node 31, a set of a public key and data signed with a secret key, or an access token.

(Step S102: Data Request Process)

The acquisition request reception unit 111 receives the transfer-source data acquisition request 501. The data acquisition unit 112 uses the transfer-source data acquisition request 501 to request a transaction recorded in a ledger indicated by the acquisition object ledger name and supplementary data 503 related to the transaction, from the connection transfer-source node.

(Step S103: Request Data Transmission Process)

The connection transfer-source node transfers the transaction requested by the data acquisition unit 112 and the supplementary data 503 to the data acquisition unit 112.

(Step S104: Selection Process)

The data acquisition unit 112 acquires the transaction and the supplementary data 503 as acquisition data. The data selection unit 113 selects only data necessary in a transfer process from the acquisition data.

As a specific example, when the transfer-source distributed ledger is a blockchain, in the transfer-source ledger network 3, a plurality of transactions are managed in groups called a block. In this case, the data acquisition unit 112 may acquire a block from the transfer-source node 31, and the data selection unit 113 may extract each transaction from the block acquired by the data acquisition unit 112.

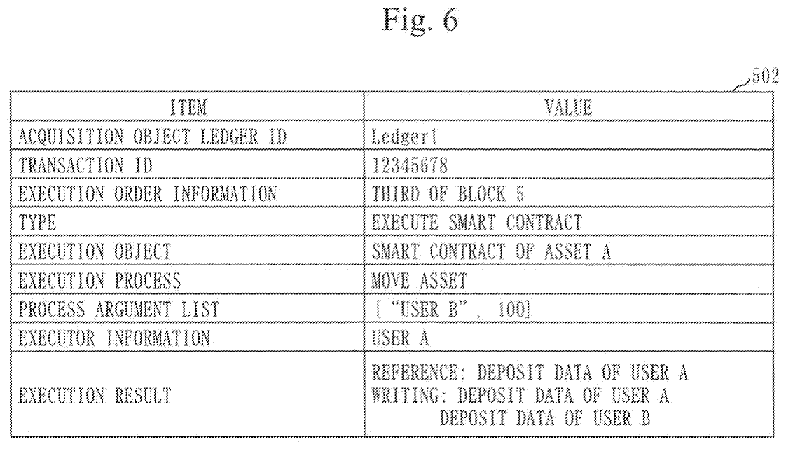

FIG. 6 illustrates an example of the selected transaction data 502. The selected transaction data 502 is transaction data selected by the data selection unit 113.

“Acquisition object ledger ID” is an identifier to uniquely describe a ledger being an object to be obtained data. The value of “acquisition object ledger ID” is the same value as the acquisition object ledger ID set by the transfer-source data acquisition request 501.

“Transaction ID” is an identifier uniquely describing a transaction included in the acquisition object ledger. Hereinafter, in the description of the present diagram, a transaction is a transaction indicated by the transaction ID unless otherwise specified.

“Execution order information” is information to describe the timing when a transaction is applied to the ledger. When the transfer-source distributed ledger is a blockchain, for example, the value of “execution order information” is created by combining a block number and information indicating what number that the transaction was applied to in a block. Further, the execution order information may be generated using a list of transactions that should be processed before executing a certain transaction.

“Type” describes a kind of process executed by the transaction. The type of the process is, as a specific example, any of distributed ledger embedded function execution, smart contract execution, smart contract deployment and smart contract update.

“Execution object” describes a location where the process executed by the transaction is defined. The execution object may be information indicating a location where the function embedded in the distributed ledger is stored, or may be information to indicate a smart contract being a logic which operates in the blockchain.

“Execution process” describes a schematic process executed by the transaction. The value of “execution process” is, as a specific example, any of a function embedded in the distributed ledger, deployment or update of the smart contract, and the process defined in the smart contract.

“Process argument list” is a list wherein a data group required by a process indicated in the execution process is set.

“Executor information” is information which indicates an executor of a transaction.

“Execution result” describes an execution result of the transaction when a process indicated in the execution process is performed using an argument indicated in the process argument list as for an object indicated in the execution object. The value of “execution result” is, as a specific example, constituted by two types of information including reference information indicating data referred to and writing information indicating data written, in the execution of the process. Typically, a status DB (database) being a storage area for process execution in the transfer-source node 31 stores the reference information and the writing information. The reference information is, for example, all the main keys of the status DB referred to at the time of processing execution. The writing information is, for example, all the main keys of the status DB written at the time of processing execution.

A case is considered wherein a distributed ledger whereof the execution result is not included in a transaction is used. In this case, as a specific example, when the distributed ledger supports a function to store arbitrary data in a storage area which makes it possible to follow a transaction or a relation with the transaction at the time of process execution, the data selection unit 113 may use the function. Specifically, by recording the main key of the data referred to and the main key of the data written at the time of executing the smart contract in the storage area which makes it possible to follow the transaction or the relation with the transaction, it is possible for the data selection unit 113 to acquire the execution result at the time when the data is acquired from the data acquisition unit 112. The data selection unit 113 may combine the execution result acquired by this procedure with the transaction, and may also manage the execution result as the supplementary data 503.

Further, the data selection unit 113 may obtain the execution result by emulating execution of the transaction by an arbitrary means without using the function as mentioned above, and may register the execution result obtained as the supplementary data 503 with the supplementary data management unit 14 using the supplementary data registration request unit 22.

The selected transaction data 502 illustrated as an example in FIG. 6 is a transaction to execute a smart contract deployed to the distributed ledger. By assuming that the type is smart contract deployment or smart contract update, it is possible for the selected transaction data 502 to express a transaction related to deployment or update of the smart contract. In this case, it is assumed that a smart contract name to be deployed or updated is set as a value of the execution object.

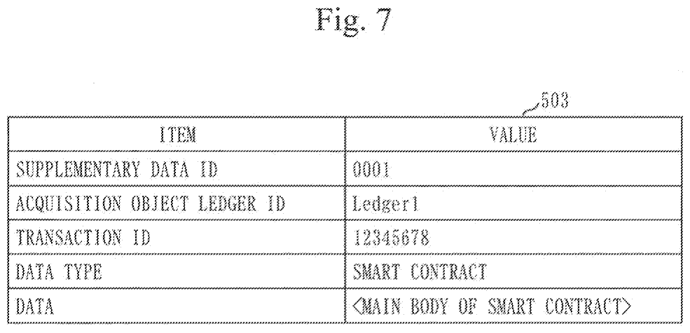

FIG. 7 illustrates an example of the supplementary data 503. The supplementary data 503 is selected by the data selection unit 113.

“Supplementary data ID” is an identifier uniquely representing the supplementary data 503.

“Acquisition object ledger ID” is an identifier uniquely representing a ledger being a data acquisition object. The value of “acquisition object ledger ID” is the same value as the value indicated in the acquisition object ledger ID of the transfer-source data acquisition request 501. Hereinafter, in the description of the present diagram, ledgers are ledgers indicated by the acquisition object ledger IDs unless otherwise specified.

“Transaction ID” is an identifier uniquely representing a transaction included in a ledger. The value of “transaction ID” is an identifier of the transaction related to the supplementary data 503.

“Data type” represents a type of the supplementary data 503. As a specific example, the type of the supplementary data 503 is any of “smart contract” indicating that the supplementary data 503 represents data of a main body of the smart contract, “secret data” representing that the supplementary data 503 is secret data not recorded directly in the ledger, and “execution result” used when a distributed ledger whereof the execution result is not included in the transaction is used.

“Data” is a main body of the supplementary data 503. The value of “data” is, as a specific example, when the supplementary data 503 is a smart contract, data of a main body of the smart contract used at the time of deploying the smart contract to a node. As a specific example, when the supplementary data 503 is the secret data, the value of “data” is data of the main body of the secret data. When the supplementary data 503 is the execution result, the value of the data is, for example, a value equivalent to “execution result” of FIG. 6.

(Step S105: Selection Data Transmission Process)

The data selection unit 113 transmits the selected transaction data 502 from among the data finally selected, to the transfer order creation unit 12, and transmits the supplementary data 503 to the supplementary data management unit 14.

(Step S106: Supplementary Data Readout Process)

The transaction-relation data creation unit 121 reads out from the supplementary data record unit 142 the supplementary data 503 related to the selected transaction data 502 received from the data selection unit 113.

(Step S107: Transaction-Relation Data Creation Process)

The transaction-relation data creation unit 121 creates transaction-relation data using the selected transaction data 502 and the supplementary data 503. The transaction-relation data is data to support deriving an efficient order to register transactions with the transfer-destination ledger network 4.

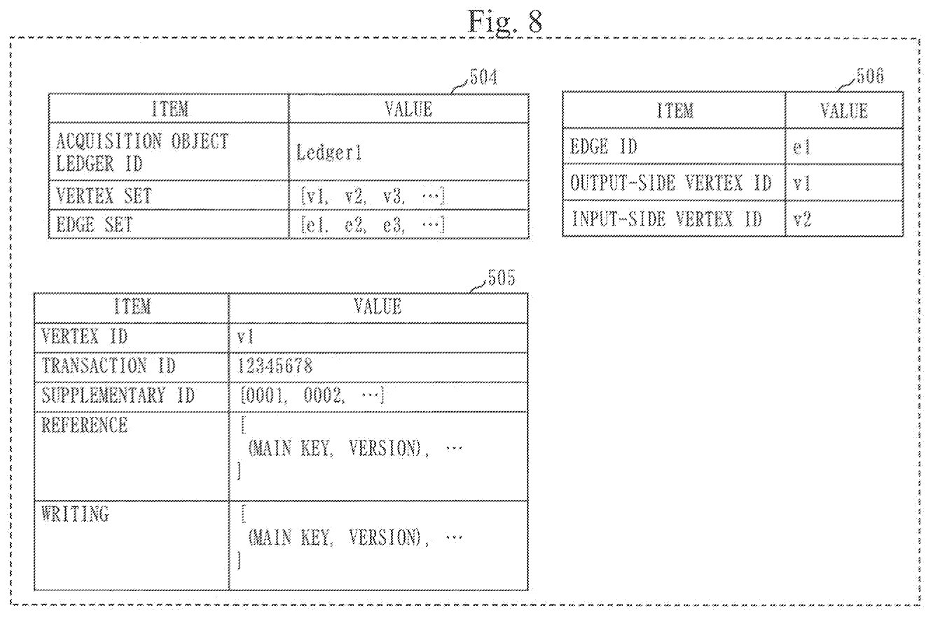

FIG. 8 illustrates an example of the transaction-relation graph 504, and each example of vertex data 505 and edge data 506 being components of the transaction-relation graph 504. The transaction-relation graph 504 is one example of the transaction-relation data using a data format of a graph structure. One vertex of the transaction-relation graph 504 corresponds to one piece of the vertex data 505. One edge of the transaction-relation graph 504 corresponds to one piece of the edge data 506.

Description will be made on each item in the transaction-relation graph 504 as illustrated in FIG. 8.

“Acquisition object ledger ID” is an identifier to uniquely represent a ledger being the data acquisition object. Hereinafter, in the description of the present diagram, ledgers are ledgers indicated by the acquisition object ledger IDs unless otherwise specified.

“Vertex set” is a list of vertex IDs of the vertex data 505 that constitute the transaction-relation graph.

“Edge set” is a list of edge IDs of the edge data 506 that constitute the transaction-relation graph. Each of the vertex set and the edge set only needs to retain each piece of information of the vertexes and the edges that constitute the transaction-relation graph. Therefore, the vertex set may be a list of the vertex data 505, and the edge set may be a list of the edge data 506.

Description will be made on each item in the vertex data 505 as illustrated in FIG. 8.

“Vertex ID” is an identifier uniquely representing a vertex. Hereinafter, in the explanation of the vertex data 505, vertexes indicate vertexes represented by the vertex IDs.

“Transaction ID” is an identifier uniquely representing a transaction included in a ledger.

“Supplementary data ID” is a list of supplementary data IDs related to a transaction described by a transaction ID.

“Reference” is a list of pairs of a main key of a status DB referred to in executing a transaction corresponding to a vertex, and a version of the main key. The version of the main key is information indicating the number of times or a period the main key is updated in the status DB. As a specific example, it is possible to use information indicating an execution order of the transaction wherein the value of the main key is updated or a value of a version managed by a version management function incorporated in the status DB.

“Writing” is a list of pairs of a main key of a status DB written in executing a transaction corresponding to a vertex, and a version of the main key.

Description will be made on each item in the edge data 506 illustrated in FIG. 8.

“Edge ID” is an identifier uniquely describing an edge. Hereinafter, edges are edges indicated by edge IDs in the description of the edge data 506 unless otherwise specified.

“Output-side edge vertex ID” describes a vertex ID of a vertex whereof an edge is output.

“Input-side edge vertex ID” describes a vertex ID of a vertex whereof an edge is input.

As a specific example, it is assumed a case wherein an edge ID is e1, an output-side vertex ID is v1 and an input-side vertex ID is v2. In this case, the edge e1 represents a restriction with respect to the transfer-destination distributed ledger that a transaction corresponding to the vertex v2 must be registered after registration of a transaction corresponding to the vertex v1 at the time of transferring data.

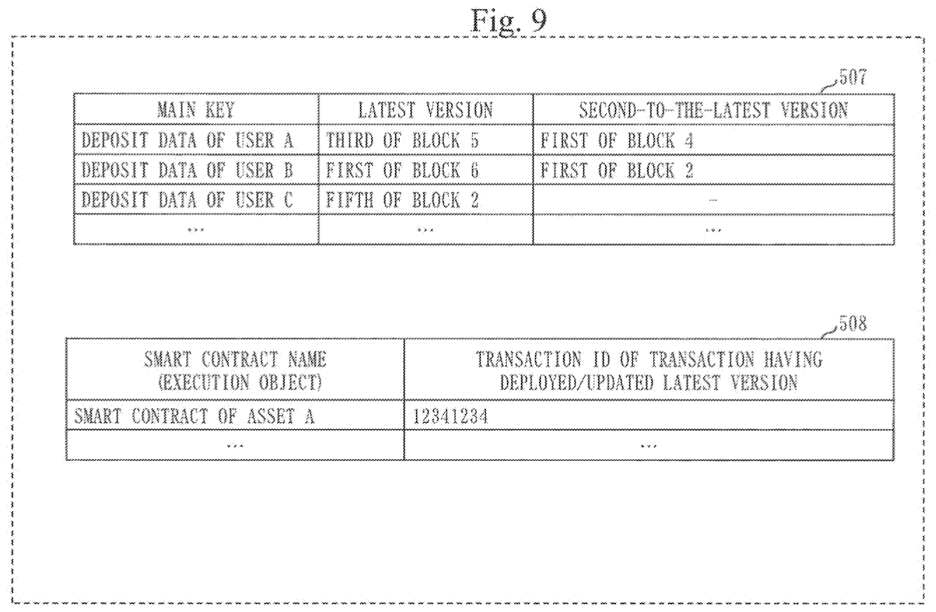

FIG. 9 illustrates an example of a main key update history table 507 and an example of a smart contract update history table 508.

The main key update history table 507 is data used in the course of creating the transaction-relation graph 504, which indicates, in a status DB at a certain point of time of the transfer-source distributed ledger, the latest version of each main key recorded in the status DB and a version before the latest version.

In the present example, information indicating an execution order of a transaction in a blockchain is used as a version. The data on the first line of the present example represents that “deposit data of User A” being a main key is updated last by executing the third transaction of a block 5, and further, the “deposit data of User A” is updated last but one by executing the transaction on the first transaction of a block 4.

The smart contract update history table 508 is data used in the course of creating the transaction-relation graph 504. In the present example, the smart contract update history table 508 is constituted by “smart contract name” indicating a name of a smart contract being the execution object and “transaction ID of transaction wherein the latest version deployed/updated” indicating a transaction ID of the transaction wherein the latest version of a smart contract which is deployed to the transfer-source distributed ledger deployed or updated, at a certain point of time.

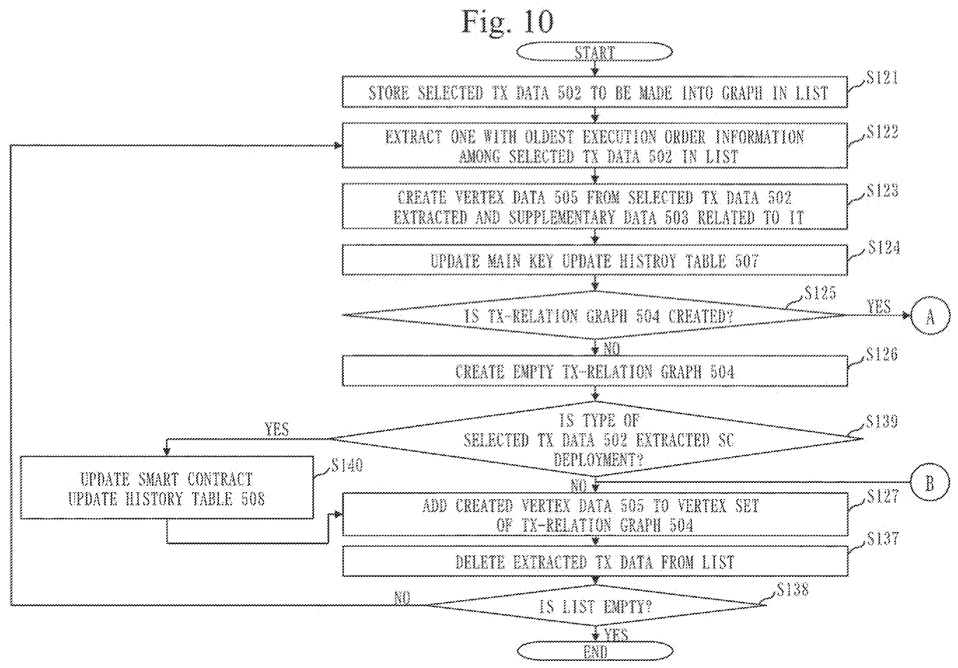

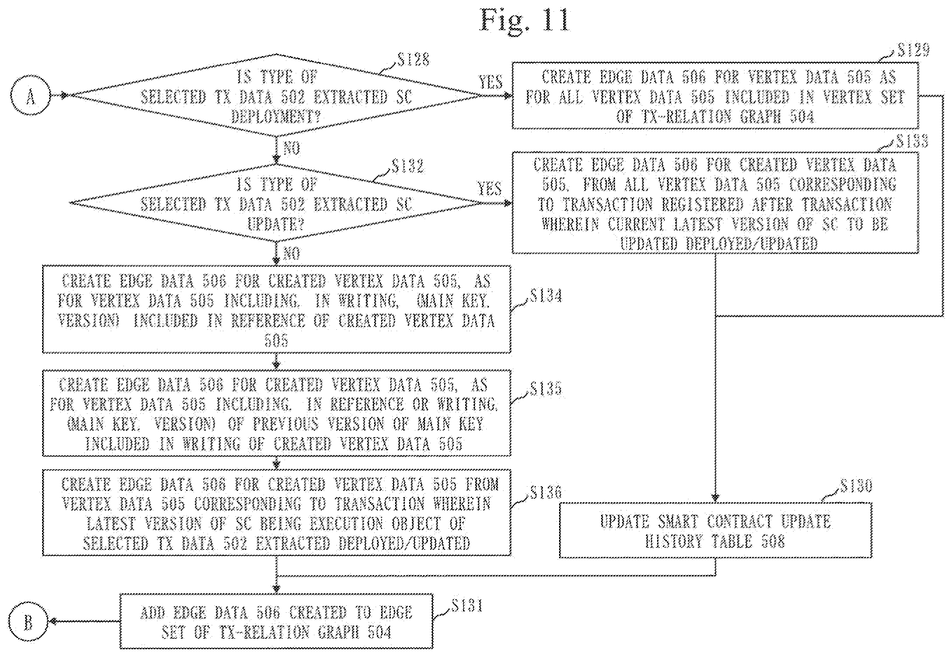

FIG. 10 and FIG. 11 are flowcharts illustrating an example of operations when the transaction-relation data creation unit 121 creates a transaction-relation graph. With reference to these diagrams, description will be made on a process of the transaction-relation data creation unit 121. One flowchart is divided into FIG. 10 and FIG. 11. TX is an abbreviation for transaction. SC is an abbreviation for smart contract.

(Step S121)

The transaction-relation data creation unit 121 stores in a list the selected transaction data 502 to be made into a graph.

(Step S122)

The transaction-relation data creation unit 121 extracts from among the selected transaction data 502 in the list one piece with an oldest execution order indicated by the execution order information. In the following steps in the present flowchart, the selected transaction data 502 indicates selected transaction data 502 extracted in the present steps.

(Step S123)

The transaction-relation data creation unit 121 creates vertex data 505 using the selected transaction data 502, and the supplementary data 503 related to the selected transaction data 502. Hereinafter, in the description of the present flowchart, “created vertex data 505” indicates the vertex data 505 created here unless otherwise specified until the transaction-relation data creation unit 121 performs the process of the present step next. That is, every time the transaction-relation data creation unit 121 performs the process of the present step, the vertex data 505 indicated by “created vertex data 505” is updated.

Description will be made on a specific example of a method to create the vertex data 505. The transaction-relation data creation unit 121 newly generates a value so as not to overlap with the vertex IDs created before the transaction-relation data creation unit 121 performs the process of the present step after starting the process indicated in the present flowchart, sets the value generated in “vertex ID”, sets the transaction ID of the selected transaction data 502 in “transaction ID”, and sets the ID of the supplementary data 503 in “supplementary data ID”. When there is no supplementary data 503 related to the selected transaction data 502, the transaction-relation data creation unit 121 sets an empty list in the supplementary data ID. The transaction-relation data creation unit 121 uses reference data indicated by the execution result of the selected transaction data 502 or the execution result of the supplementary data 503 related to the selected transaction data 502, and the main key update history table 507, to set a set of the main key and a version of the main key in “reference”. Specifically, the latest version of each main key in the reference data of the execution result is read from the main key update history table 507, and the main key and the latest version are set as a set. When there is no reference data of the execution result, the transaction-relation data creation unit 121 does not set “reference”. The transaction-relation data creation unit 121 uses writing data indicated by the execution result of the selected transaction data 502, or by the execution result of the related supplementary data 503, the execution order information of the selected transaction data 502 or the main key update history table 507, etc., and sets a set of the main key and the version of the main key in “writing”. When using the execution order information as the version of the main key, the transaction-relation data creation unit 121 sets the set of the main key and the execution order information of the selected transaction data 502 in “reference” and “writing”. In addition, when it is possible to derive the version of the main key written in the status DB by the selected transaction data 502 extracted, from the main key update history table 507, the transaction-relation data creation unit 121 may set the set of the main key and the version derived from the main key update history table 507 in “reference” and “writing”. As a specific example in this case, there is a method to manage version information in natural numbers, such as 1, 2, 3, . . . , and to use a rule wherein a value of a new version becomes a value obtained by adding one to a value of the latest version indicated in the main key update history table 507. When there is no writing data of the execution result, the transaction-relation data creation unit 121 does not set “writing”.

(Step S124)

The transaction-relation data creation unit 121 updates the main key update history table 507. As a specific example, for each main key set in “writing” in the created vertex data 505, the version set as the latest version in the main key update history table 507 is set as the second-to-the-latest version, and then, the version set in “writing” is set as the latest version. When “writing” of the created vertex data 505 is not set, the transaction-relation creation unit 121 skips the process of the present step.

(Step S125)

The transaction-relation data creation unit 121 confirms whether the transaction-relation graph 504 is created.

When the transaction-relation graph 504 is created, the transaction-relation data creation unit 121 proceeds to Step S128. In other cases, the transaction-relation data creation unit 121 proceeds to Step S126.

(Step S126)

The transaction-relation data creation unit 121 creates an empty transaction-relation graph 504. In the following steps of the present flowchart, the transaction-relation graph 504 denotes the transaction-relation graph 504 created in the present step.

As a specific example, when the selected transaction data 502 is transaction data read out first, the transaction-relation data creation unit 121 sets the value described by the “acquisition object ledger ID” of the selected transaction data 502 in “acquisition object ledger ID,” and sets an empty list in each of “vertex set” and “edge set”.

(Step S127)

The transaction-relation data creation unit 121 adds the created vertex data 505 in Step 123 to “vertex set” of the transaction-relation graph 504.

(Step S128)

The transaction-relation data creation unit 121 confirms whether “type” of the selected transaction data 502 is smart contract deployment or not.

When “type” is smart contract deployment, the transaction-relation data creation unit 121 proceeds to Step S129. In other cases, the transaction-relation data creation unit 121 proceeds to Step S132.

(Step S129)

The transaction-relation data creation unit 121 creates edge data 506 for vertexes corresponding to the created vertex data 505 with respect to a vertex corresponding to each of all the vertexes described in “vertex set” of the transaction-relation graph 504.

(Step S130)

The transaction-relation data creation unit 121 records a set of a name of the smart contract deployed or updated, and a transaction ID of the selected transaction data 502 in the smart contract update history table 508. The transaction-relation data creation unit 121 sets “smart contract name” being the same as that in “execution object” of the selected transaction data 502.

(Step S131)

The transaction-relation data creation unit 121 adds the edge data 506 created to “edge set” of the transaction-relation graph 504.

(Step S132)

The transaction-relation data creation unit 121 confirms whether “type” of the selected transaction data 502 is smart contract update or not.

When “type” is smart contract update, the transaction-relation data creation unit 121 proceeds to Step S133. In other cases, the transaction-relation data creation unit 121 proceeds to Step S134.

(Step S133)

The transaction-relation data creation unit 121 creates edge data 506 for the created vertex data 505 using each of all pieces of the vertex data 505 corresponding to transactions registered at or after the time indicated by the transaction having deployed or updated the current latest version of the smart contract to be updated.

As a specific example, the transaction-relation data creation unit 121 acquires a smart contract name set in “execution object” of the selected transaction data 502, and acquires, from the smart contract update history table 508, a transaction ID of the transaction having deployed or updated the latest version of the smart contract corresponding to the smart contract name acquired. Further, the transaction-relation data creation unit 121 acquires selected transaction data 502 corresponding to the transaction ID acquired, and extracts “execution order information” of the selected transaction data 502 acquired. The transaction-relation data creation unit 121 searches for the selected transaction data 502 registered at or after a time indicated by “execution order information”, and acquires vertex data 505 corresponding to each piece of the selected transaction data 502 registered at or after the time. Then, the transaction-relation data creation unit 121 creates each piece of edge data 506, having each piece of the vertex data 505 acquired and the created vertex data 505 as both ends. The smart contract name is the same as that in “execution object” of the selected transaction data 502.

(Step S134)

The transaction-relation data creation unit 121 creates edge data 506 having as both ends the created vertex data 505, and vertex data 505 including a set of a main key and a version of the main key included in “reference” of the created vertex data 505, as an element of “writing”.

(Step S135)

The transaction-relation data creation unit 121 creates edge data 506 having as both ends the created vertex data 505, and vertex data 505 including, as an element of “reference” or “writing”, a set of a main key of a previous version of the main key and the version of the main key of the previous version, which is included in “writing” of the created vertex data 505.

(Step S136)

The transaction-relation data creation unit 121 acquires a transaction ID of a transaction having deployed or updated the latest version of a smart contract indicated in “execution object” of the selected transaction data 502, using “execution object” of the selected transaction data 502 and the smart contract update history table 508, and creates edge data 506 having the created vertex data 505, and vertex data 505 corresponding to the transaction of the transaction ID acquired, as both ends.

(Step S137)

The transaction-relation data creation unit 121 deletes transaction data extracted in Step S122 from the list.

(Step S138)

The transaction-relation data creation unit 121 confirms whether the list is empty or not.

When the list is empty, the transaction-relation data creation unit 121 finishes the process of the present flowchart. When the list is not empty, the transaction-relation data creation unit 121 proceeds to Step S121.

(Step S139)

The process in the present step is equivalent to the process in Step S128.

(Step S140)

The process in the present step is equivalent to the process in Step S130.

(Step S108: Data Record Process)

The transaction-relation data creation unit 121 records in the transaction-relation data record unit 122 the transaction-relation data generated and the selected transaction data 502 received from the data selection unit 113.

As the transaction-relation data recorded in the transaction-relation data record unit 122, when the transaction-relation data is the transaction-relation graph 504, there are the transaction-relation graph 504, the vertex data 505 and the edge data 506 constituting the transaction-relation graph 504.

(Step S109: Supplementary Data Transmission Process)

When external supplementary data 503 is necessary, the supplementary data registration request unit 22 transmits the supplementary data 503 to the data transfer device 1.

The timing to transmit the supplementary data 503 may be before or in the middle of the process of the data extraction unit 11 or the transfer order creation unit 12 as described. The data transfer device 1 receives the supplementary data 503 using the supplementary data reception unit 141, and records the supplementary data 503 received in the supplementary data record unit 142.

(Step S110: Registration Request Transmission Process)

The registration request unit 212 transmits the transfer-destination data registration request 509 to the data transfer device 1.

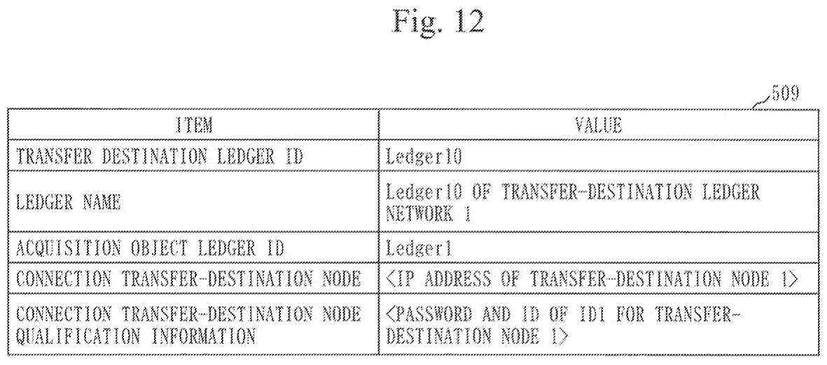

FIG. 12 illustrates an example of the transfer-destination data registration request 509.

“Transfer-destination ledger ID” is an identifier to uniquely represent a ledger being a transfer destination.

“Ledger name” is a name set to the ledger being the transfer destination.

“Acquisition object ledger ID” is an identifier to uniquely represent a ledger being a transfer source.

“Connection transfer-destination node” is information representing a location of the transfer-source node 41 to connect, whereto the data transmission unit 133 transfers data, similarly to “connection transfer-source node”.

“Connection transfer-destination node qualification information” is information used in a case wherein authentication is necessary in connecting to the transfer-destination node 41, similarly to “connection transfer-source node qualification information”.

(Step S111: Transfer Data Creation Process)

The data transfer device 1 receives a transfer-destination data registration request 509 using the registration request reception unit 131, and calls the data creation unit 132.

The data creation unit 132 creates transfer data 510 using a transfer-destination data registration request 509 received by the registration request reception unit 131, transaction-relation data recorded in the transaction-relation data record unit 122 and supplementary data 503 recorded by the supplementary data record unit 142, and appropriately transmits the transfer data 510 created to the data transmission unit 133.

FIG. 3 illustrates an example of the transfer data 510.

“Order data” is a set value representing an order to apply the transfer data 510 to the transfer-destination ledger network 4. When a plurality of pieces of transfer data 510 exist, it is made possible to uniquely specify an application order of the transfer data 510 by setting mutually different values to “order data” of each piece of the transfer data 510.

“Ledger name” is a name set to the ledger being the transfer destination.

“Connection transfer-destination node” is information to represent a location of the transfer-destination node 41 whereto the data transmission unit 133 connects, similarly to “connection transfer-source node”.

“Connection transfer-destination node qualification information” is information used when authentication is necessary in connecting to the transfer-destination node 41, similarly to “connection transfer-source node qualification information”.

“Vertex data list” is a list including elements corresponding to the vertex data 505 to be transferred. Each element included in “vertex data list” corresponds to a creation element, and corresponds to at least a part of electronic data to be transferred from the transfer-source distributed ledger to the transfer-destination distributed ledger. Since the vertex data 505 corresponding to the elements included in “vertex data list” indicates data that can be registered at the timing when the transfer data 510 is generated, the data transfer device 1 may register data indicated by the vertex data 505 with the transfer-destination ledger network 4 in any order. However, when a plurality of pieces of the transfer data 510 exist, it is necessary for the data transfer device 1 to register the vertex data 505 in an order from the transfer data 510 with a preceding order indicated in “order data”.

Hereinafter, it is illustrated a specific example of creation and transmission of the transfer data 510 in a case wherein the data transfer device 1 adopts the transaction-relation graph 504 as transaction-relation data.

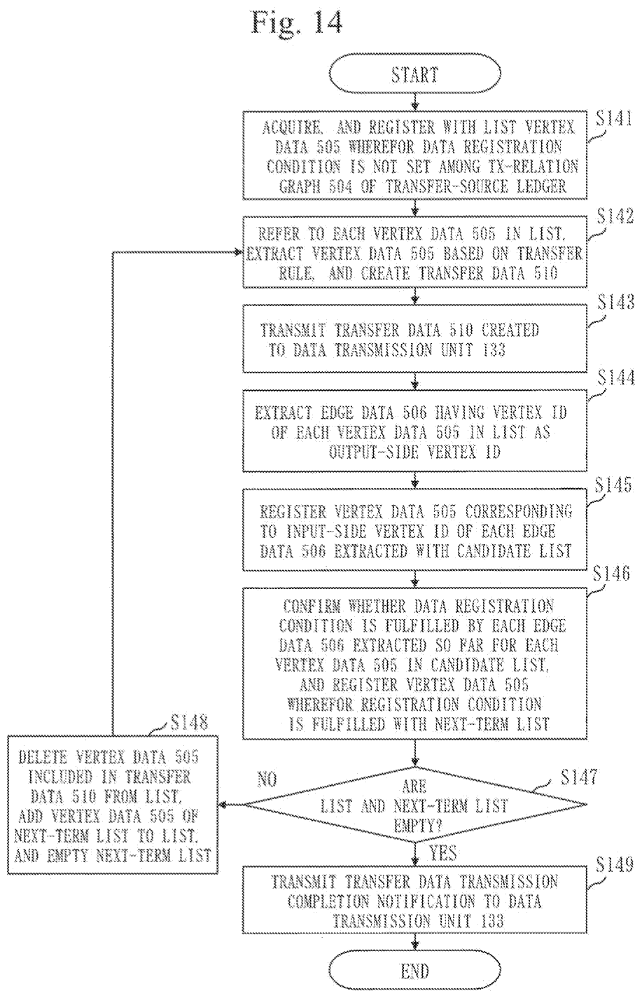

FIG. 14 is a flowchart illustrating an example of a process to create transfer data 510, and a process to transmit the transfer data 510 created to the data transmission unit 133 by the data creation unit 132.

(Step S141)

The data creation unit 132 acquires vertex data 505 for which a data registration condition is not set from the transaction-relation graph 504 of the transfer-source distributed ledger, and registers the vertex data 505 acquired with the list. The data creation unit 132 uses “acquisition object ledger ID” of the transfer-destination data registration request 509, and acquires a transaction-relation graph 504 corresponding to the transfer-source distributed ledger from the transaction-relation data record unit 122. The vertex data 505 for which the data registration condition is not set is vertex data 505 that is not set as “input-side vertex ID” of edge data 506 corresponding to an edge included in “edge set” of the transaction-relation graph 504, among the vertex data 505 corresponding to the vertexes included in “vertex set” of the transaction-relation graph 504.

(Step S142)

The data creation unit 132 refers to each piece of the vertex data 505 inside the list, extracts vertex data 505 based on the transfer rule, and creates transfer data 510 using the vertex data 505 extracted.

As the transfer rule, for example, there is a rule to include all pieces of the vertex data 505 included in the list, in the transfer data 510. As s specific example, description will be made on a case using a blockchain as a distributed ledger. In this case, since it is possible to reduce a consensus building time for each transaction by unifying a plurality of pieces of vertex data 505 included in the list as one piece of block data, it is possible to shorten the time required for data transfer. As another transfer rule, there is also a rule to generate transfer data 510 using more preferentially vertex data 505 corresponding to a transaction constituting a precondition for registering more transactions. When this rule is applied in using the blockchain, the data creation unit 132 generates transfer data 510 using more preferentially the vertex data 505 corresponding to the transaction constituting the precondition for registering more transactions, and the transfer data 510 is registered with the transfer-destination ledger network 4. In this manner, the data transfer device 1 is capable of registering a large number of transactions having such a precondition to register that transfer data 510 that is prioritized is registered. By unifying, as one block data, a group of transactions which can be registered by registering a transaction being a precondition for a large number of transactions, it is possible to reduce the time required for consensus building for each transaction; therefore, the time required for data transfer can be shortened. It is assumed that there is a distributed ledger utilizing system to manage traceability of products, wherein N is a natural number, and the system manages “unsealing a cardboard box” being a process to unseal one cardboard box wherein N pieces of products are packed, and “distribution of N pieces of products” being a process to distribute each product to a department where each product packed in the cardboard box is used. In this case, when “unsealing a cardboard box” and “distribution of N pieces of products” are recorded as traceability data, if “unsealing a cardboard box” is not performed, “distribution of N pieces of products” cannot be performed. Therefore, “unsealing a cardboard box” corresponds to “transaction being a precondition for a large number of transactions”, and in a case wherein “unsealing a cardboard box” is registered, “distribution of N pieces of products” corresponds to “a group of transactions” described above.

As transfer rules, various rules can be considered, and by suitably switching and combining transfer rules in accordance with the transaction-relation data by the data creation unit 132, it is possible for the data transfer device 1 to transfer data efficiently.

Description will be made on a specific method to create transfer data 510 using vertex data 505 extracted, by the data creation unit 132. The data creation unit 132 sets a value of “order data” so as to be applied to the transfer-destination ledger network 4 in an order from the transfer data 510 created beforehand in such a manner that the value of “order data” of the transfer data 510 is not overlapped during a repeating process of the flowchart. The data creation unit 132 sets a value indicated in the transfer-destination data registration request 509 in “ledger name,” “connection transfer-destination node” and “connection transfer-destination node qualification information” of the transfer data 510. The data creation unit 132 sets a value corresponding to the vertex data 505 included in the list in “vertex data list”. The data creation unit 132 may set the vertex data 505 itself in “vertex data list”, or may set information for referring to the vertex data 505 in “vertex data list” such as registering “vertex ID” of the vertex data 505, etc.

(Step S143)

The data creation unit 132 transmits the transfer data 510 created to the data transmission unit 133.

(Step S144)

The data creation unit 132 extracts edge data 506 having a value of “vertex ID” of each piece of vertex data 505 inside the list as a value of “output-side vertex ID”.

(Step S145)

The data creation unit 132 registers vertex data 505 corresponding to the input-side vertex ID of each piece of edge data 506 extracted with a candidate list. The data creation unit 132 does not register vertex data 505 that has already been registered with the candidate list redundantly. The candidate list is a list of vertex data 505 for which at least a part of the data registration conditions are fulfilled at the time of processing elements included in the candidate list. The data registration conditions for certain vertex data 505 are that all pieces of edge data 506 having “vertex ID” of the certain vertex data 505 as “input-side vertex ID” are extracted by the process of Step S144 during iteration by the time when the process of the present step is performed. Iteration is a repeating process in the present flowchart.

(Step S146)

The data creation unit 132 confirms, for each piece of vertex data 505 included in the candidate list, whether the data registration conditions are fulfilled or not by each piece of edge data 506 extracted by the time when the process of the present step is performed after the data creation unit 132 has started the process of the present flowchart, and registers vertex data 505 that fulfills the registration condition with a next-term list. The next-term list is a list having, as elements, vertex data 505 that wholly fulfills the data registration conditions during the process of the iteration process. Data corresponding to the vertex data 505 for which the registration conditions are fulfilled is registrable data.

Description will be made on specific examples of processes of Step S144 through Step S146. In the transaction-relation graph 504, it is assumed that an edge e1 (v1, v2), an edge e2 (v3, v2) and an edge e3 (v4, v2) exist as edge data 506 having vertex data 505 (hereinafter, vertex v2) with “vertex ID” v2, as “input-side vertex ID”. The edge e1 (v1, v2) represents edge data 506 with “edge ID” e1, “output-side vertex ID” v1 and “input-side vertex ID” v2.

In Step S144 of certain iteration, it is assumed that the edge e1 (v1, v2) is extracted from this transaction-relation graph 504. In this case, in Step S145 of the certain iteration, when the vertex v2 set in “input-side vertex ID” of the edge e1 is not already registered with the candidate list, the data creation unit 132 registers the vertex v2 with the candidate list. In Step S146 of the certain iteration, with respect to the vertex v2, since the edge e1 (v1, v2) has already been extracted among the data registration conditions, when the edge e2 (v3, v2) and the edge e3 (v4, v2) are extracted further, the vertex v2 is decided to be registrable. The data creation unit 132 confirms whether the data registration conditions are fulfilled for each vertex in this manner, and in the process of Step S146, registers vertex data 505 that fulfills the data registration conditions with the next-term list.

(Step S147)

The data creation unit 132 confirms whether the list and the next-term list are empty or not.

When the list and the next-term list are empty, the data creation unit 132 proceeds to Step S149. In other cases, that is, at least one of the list or the next-term list is not empty, the data creation unit 132 proceeds to Step S148.

(Step S148)

The data creation unit 132 deletes the vertex data 505 included in the transfer data 510 from the list, adds the vertex data 505 of the next-term list to the list, and empties the next-term list.

(Step S149)

The data creation unit 132 transmits a transmission completion notification indicating that transmission of the transfer data 510 is completed to the data transmission unit 133, and finishes the process of the present flowchart.

(Step S112: Transfer Data Transmission Process)

The data transmission unit 133 transmits data to the transfer-destination node 41 based on the transfer data 510 received from the data creation unit 132.

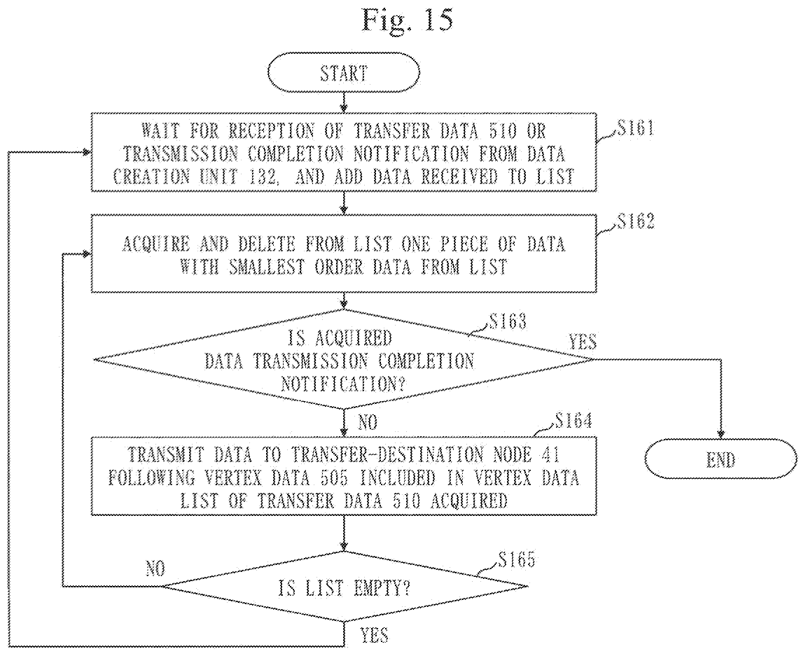

FIG. 15 is a flowchart illustrating an example of a process to transmit data to the transfer-destination node 41 by the data transmission unit 133. With reference to the present diagram, description will be made on a process of the data transmission unit 133. In the explanation of the present diagram, numerical values are set to “order data” in the transfer data 510, and processing is performed by the data transmission unit 133 in an order from a piece of transfer data 510 having “order data” with a small value.

(Step S161)

The data transmission unit 133 waits for reception of the transfer data 510 or the transmission completion notification from the data creation unit 132, and adds the data received to the list when the data is received. The data received at once is not limited to one piece. Further, the data transmission unit 133 may perform the process of the present step in the background. In this case as well, the data received from the data creation unit 132 is added to the list each time.

(Step S162)

The data transmission unit 133 acquires one piece of data including “order data” with a smallest value from the list, and deletes the data acquired from the list. The data transmission unit 133 handles the transmission completion notification as data including “order data” with a largest value.

(Step S163)

The data transmission unit 133 confirms whether the data acquired is the transmission completion notification.

When the data acquired is the transmission completion notification, the data transmission unit 133 finishes the process of the present flowchart. In other cases, that is, when the data acquired is the transfer data 510, the data transmission unit 133 proceeds to Step S164.

(Step S164)

The data transmission unit 133 follows the vertex data 505 corresponding to elements included in “vertex data list” of the transfer data 510 acquired, and transmits data to the transfer-destination node 41.

As a specific example, the data transmission unit 133 first connects to the transfer-destination node 41 using at least any of “ledger name”, “connection transfer-destination node” and “connection destination node qualification information”, etc. of the transfer data 510. Next, the data transmission unit 133 refers to at least one of the selected transaction data 502 corresponding to each piece of vertex data 505 corresponding to the elements included in “vertex data list” and the supplementary data 503, and transmits a transaction to the transfer-destination node 41 in accordance with the data referred to, or calls a function of the transfer-destination node 41, whereby data transmission to the transfer-destination node 41 is completed.

(Step S165)

The data transmission unit 133 confirms whether the list is empty.

When the list is not empty, the data transmission unit 133 proceeds to Step S162. When the list is empty, the data transmission unit 133 proceeds to Step S161.

In the description of the operations above, the data transfer objects are all transactions included in a ledger being the transfer object of the transfer-source ledger network 3. However, the data transfer objects may be a part of the transactions included in the ledger being the transfer object of the transfer-source ledger network 3.

As a specific example, the registration request unit 212 first adds information indicating a transaction being the transfer object to the transfer-source data registration request 509 in transmitting a transfer-destination data registration request 509 to the data transfer device 1. Next, the data creation unit 132 converts only information indicating the transaction being the transfer object specified into the transfer data 510 in generating transfer data 510. In this manner, it is possible for the data transfer device 1 to transfer only a part of the transactions included in the ledger being the transfer object. In this case, the data transfer device 1 may confirm if the information indicating the transaction being the transfer object specified is necessary and sufficient, and if the information is insufficient, automatically add the insufficient transaction. As a specific example, when description is made on a case wherein the transaction-relation graph 504 is used, a transaction necessary to be registered beforehand for registering a certain transaction is recorded as edge data 506. Therefore, it is possible for the data transfer device 1 to find the transaction insufficient at the time of specification, by following related vertex data 505 recursively from the edge data 506. As a specific procedure, the data creation unit 132 first acquires edge data 506 having the vertex data 505 corresponding to the information indicating the transaction being the transfer object specified as “input-side vertex ID”, and acquires the vertex data 505 set in “output-side vertex ID” of these pieces of edge data 506. Further, the data creation unit 132 recursively repeats acquisition of the edge data 506 having the vertex data 505 acquired as “input-side vertex ID”, and acquisition of the vertex data 505 which is set in “output-side vertex ID” of the edge data 506 acquired. A group of pieces of vertex data 505, which is obtained by removing an overlap with a group of pieces of vertex data 505 corresponding to the information indicating the transaction being the transfer object specified first from the group of pieces of vertex data 505 acquired in a process of recursive search represents the insufficient transaction. A sum set of the group of pieces of vertex data 505 acquired in the process of recursive search, and the group of pieces of vertex data 505 corresponding to the information indicating the transaction being the transfer object specified first is a transaction necessary in transferring data corresponding to the information indicating the transaction being the transfer object specified.

In the explanation of the operations as above, it has been described the operations at the time when the data transfer device 1 transfers one transfer-source distributed ledger to one transfer-destination distributed ledger. However, the data transfer device 1 may transfer a plurality of transfer-source distributed ledgers to one transfer-destination distributed ledger by taking as a condition that a plurality of transfer-source distributed ledgers do not include transactions with the same contents. Therefore, the data transfer device 1 may have a configuration to transfer data by organizing transactions of the plurality of transfer-source distributed ledgers that do not include transactions with the same contents in an overlapping manner, and allotting data to the plurality of transfer-destination distributed ledgers.

### Description of Effect of First Embodiment

As mentioned above, according to the present embodiment, it is possible to create transaction-relation data to support deriving an order to register transactions relatively efficiently with the transfer-destination ledger network 4 using selected transaction data 502 and supplementary data 503 acquired from the transfer-source ledger network 3 and manipulated, and supplementary data 503 input from the outside, by the data extraction unit 11, the transfer order creation unit 12 and the supplementary data management unit 14. Further, it is possible for the data registration unit 13 to register the transfer data 510 relatively efficiently with the transfer-destination ledger network 4 using the transaction-relation data created. Therefore, according to the present embodiment, it is possible to transfer data of transactions in a relatively efficient manner to the transfer-destination ledger network 4 with an environment different from that of the transfer-source ledger network 3.

Further, as a means to realize data transfer from a transfer-source distributed ledger to a transfer-destination distributed ledger, there is a method (hereinafter indicated as a iterative procedure) to register transactions having the same contents with the transfer-destination distributed ledger one to one, in an order from the oldest transaction stored in the transfer-source distributed ledger.

In the iterative procedure, transactions are registered one to one with the transfer-destination distributed ledger so as to definitely match an order of transactions to be registered with the transfer-destination distributed ledger with a registration order of transactions in the transfer-source distributed ledger. However, in distributed ledgers, a plurality of nodes perform consensus building. Therefore, there is a problem that it takes time from registration request until registration completion of transactions, which lengthens the time required for data transfer. In a blockchain being a kind of distributed ledgers, a plurality of transactions are unified, and data is registered in a unit called a block. Since consensus building is performed by the block, it is possible to shorten the time required for consensus building for each transaction by including a plurality of transactions in one block. However, in this case, there is no existing technique to specify an application order of transactions, and there is a possibility that the registration order of transactions in the transfer-source distributed ledger does not match with the registration order of transactions in the transfer-destination distributed ledger. Therefore, it is impossible to use the method to simply unify a plurality of transactions in a block. However, according to the present embodiment, it is possible to unify a plurality of transactions which can be registered with the transfer-destination distributed leger, and transfer the plurality of transactions to the transfer-destination distributed ledger. Therefore, according to the present embodiment, it is possible to transfer electronic data from the transfer-source distributed ledger to the transfer-destination distributed ledger more efficiently than in a case wherein the iteration procedure is adopted.

***Other Configuration***

### <First Variation>

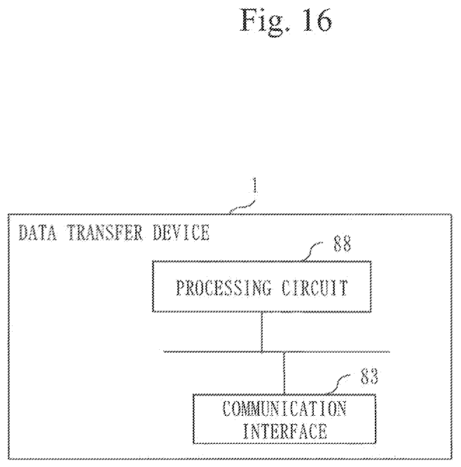

FIG. 16 illustrates a configuration example of hardware of the data transfer device 1 according to a present variation.

The data transfer device 1 includes, as illustrated in the present diagram, a processing circuit 88 instead of at least one of the processor 81, the memory 82 and the auxiliary storage device 84.

The processing circuit 88 is a hardware component to realize at least a part of each unit included in the data transfer device 1.

The processing circuit 88 may be a dedicated hardware component, or may be a processor to execute a program stored in the memory 82.

When the processing circuit 88 is the dedicated hardware component, the processing circuit 88 is, for example, a single circuit, a composite circuit, a processor made into a program, a processor made into a parallel program, an ASIC (application specification integrated circuit), an FPGA (field programmable gate array), or a combination thereof.

The data transfer device 1 may include a plurality of processing circuits replacing the processing circuit 88. The plurality of processing circuits share roles of the processing circuit 88.

In the data transfer device 1, a part of the functions may be realized by the dedicated hardware component, and the rest of the functions may be realized by software or firmware.

The processing circuit 88 is, for example, realized by hardware, software, firmware or a combination thereof.

The processor 81, the memory 82, the auxiliary storage device 84 and the processing circuit 88 are collectively called “processing circuitry”. That is, the functions of each functional component of the data transfer device 1 are realized by the processing circuitry.

Each of the other devices included in the data transfer system 90 and each device included in the data transfer system 90 according to the other embodiments may have a configuration equivalent to that of the present variation.

### Second Embodiment

Hereinafter, description will be made mainly on parts different from those of the embodiment described above, with reference to diagrams.

***Description of Configuration***

In the first embodiment, description has been made on the case wherein a delegation capable of connecting to the transfer-source ledger network 3 and the transfer-destination ledger network 4, and registering transactions being the transfer object included in the transfer-source ledger network 3 with the transfer-destination ledger network 4 transfers data using one data transfer device 1.

In the present embodiment, when an acquisition privilege of transactions being the transfer object included in the transfer-source ledger network 3 is set, or when a registration privilege of transactions with the transfer-destination ledger network 4 is set, and so on, a plurality of participants transfer data cooperatively with a plurality of data transfer devices 1. The participants are users of the data transfer devices 1, or the data transfer devices 1. The users may be computers, etc.

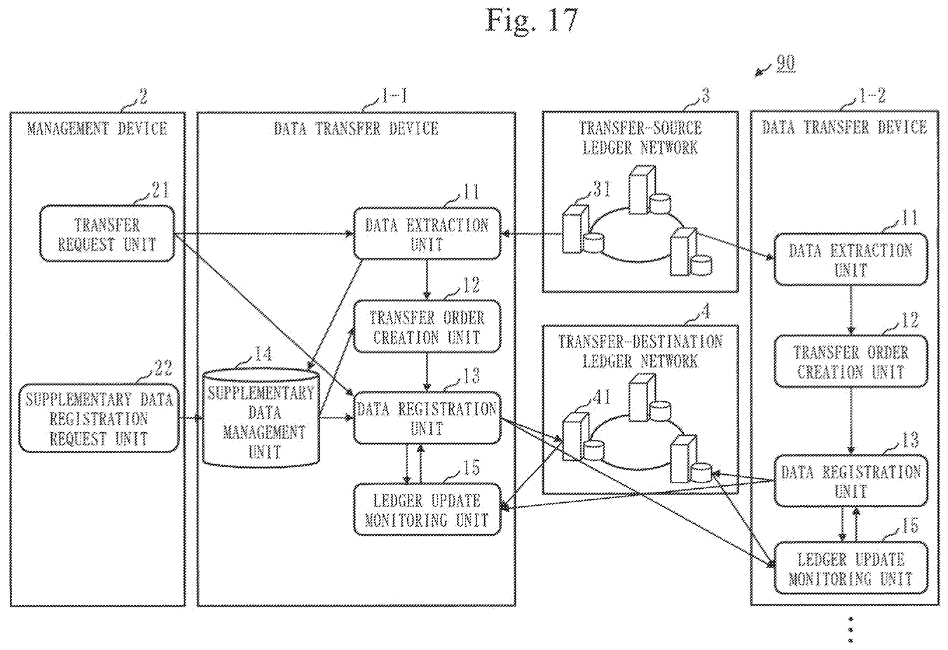

FIG. 17 illustrates a configuration example of the data transfer system 90 according to the present embodiment. Main differences of the present embodiment with the first embodiment are that the data transfer system 90 includes a plurality of data transfer devices 1, that each data transfer device 1 includes a ledger update monitoring unit 15, and that a communication path from the data registration unit 13 of each data transfer device 1 to the ledger update monitoring unit 15 of each data transfer device 1 being a cooperation object is added. In the present embodiment, a data transfer system 90 including one other data transfer device 1 equipped with the same function as a function of the data transfer device 1 includes the data transfer device 1. Any data transfer device 1 is connected to the transfer-source ledger network 3 and the transfer-destination ledger network 4. In order to distinguish the plurality of data transfer devices 1, “−1,” etc. is used. By making the data transfer system 90 have this configuration, it is possible for each of the plurality of pieces of data transfer devices 1 to transfer a suitable transaction at a suitable timing while confirming a progress state of data transfer by the ledger update monitoring unit 15.

In the present diagram, it is described a case wherein the data transfer device 1 communicates directly with the other data transfer device 1. However, the data transfer device 1 may communicate with the other data transfer device 1 via some device or means, etc. For example, as a mediation means which can be accessed by each data transfer device 1, the data transfer system 90 may include a data store such as a DB (database) or a data lake, etc., a message delivery system such as a message queue, etc., or a distributed ledger system, etc., and both data transfer devices 1 may switch data via the mediation means. Further, in a case wherein the transfer-destination node 41 is capable of adding arbitrary data related to transactions, communication between the plurality of data transfer devices 1 may be realized via the transfer-destination node 41.

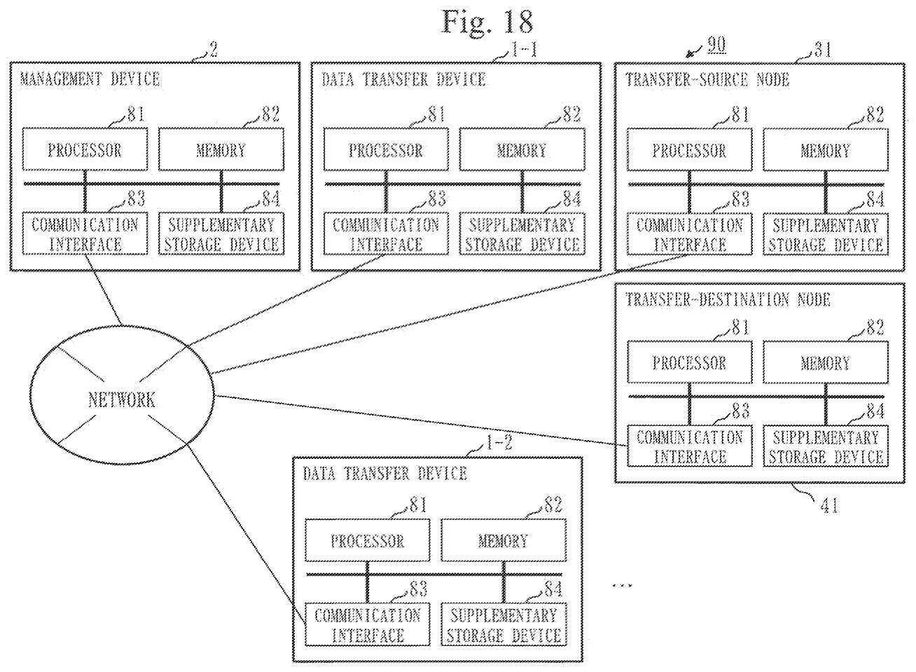

FIG. 18 illustrates a configuration example of hardware of each device included in the data transfer system 90. A main difference of the present embodiment with the first embodiment is that in order for each data transfer device 1 to communicate with the other data transfer device 1, both data transfer devices 1 are configured to join the same network. However, in a case wherein communication between the data transfer devices 1 is realized via the transfer-destination node 41, the hardware configuration may be the same as the hardware configuration of the data transfer device 1 in the first embodiment.

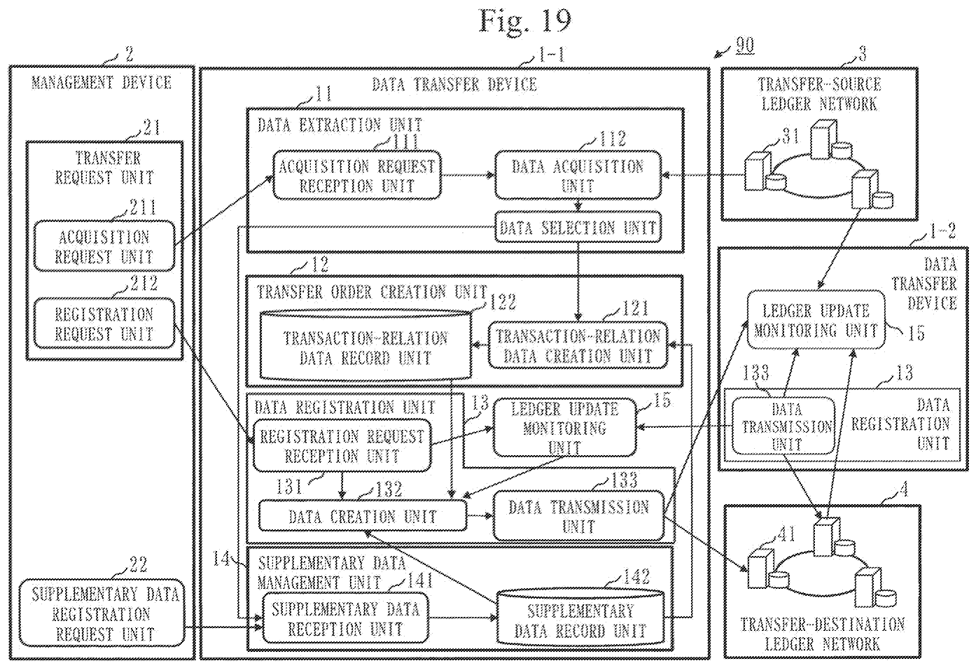

FIG. 19 illustrates a configuration example of software of each device included in the data transfer system 90. A main difference of the present embodiment with the first embodiment is that the data transfer device 1 includes the ledger update monitoring unit 15.

The ledger update monitoring unit 15 receives at least any of the transfer-destination node 41, the transfer-destination distributed ledger, and the ledger ID of the transfer-destination distributed ledger, etc. from the registration request reception unit 131, and monitors a status of transaction registration in the transfer-destination distributed ledger being the object. Further, the ledger update monitoring unit 15 receives information indicating correspondence between a transaction ID in a transfer source of the transaction and a transaction ID newly set in registering the transaction in a transfer destination, from the data transmission unit 133 of the other data transfer device 1, and suitably notifies the data creation unit 132 of the received information and the status of transaction registration. The ledger update monitoring unit 15 acquires other device registration information indicating data that is received from the other data transfer device 1 and is registered with the transfer-destination distributed ledger by the transfer-destination distributed ledger.

The data creation unit 132 may create each of the creation elements, based on the data that is received from the data transmission unit 133 and is registered with the transfer-destination distributed ledger by the transfer-destination distributed ledger, and the other device registration information, while electronic data is being transferred.

The data transmission unit 133 may transmit data corresponding to each of the creation elements to the transfer-destination distributed ledger based on the other device registration information. Further, the data transmission unit 133 may transmit, to the other data transfer device 1, information indicating data that is registered with the transfer-destination distributed ledger by transmitting the data corresponding to each of the creation elements to the transfer-destination distributed ledger by the data transmission unit 133.

***Description of Operation***

Since a procedure until transaction-relation data is created is the same as that in the first embodiment, description thereof is omitted. When a transaction recorded in a ledger set in “acquisition object ledger name” and supplementary data 503 related to the transaction are acquired from the transfer-source node 31, there is a case wherein it is impossible for a data acquisition unit 112 of a certain data transfer device 1 to acquire at least a part of the transaction and the supplementary data 503 due to a reason such that an access privilege is set, or so. In this case, the certain data transfer device 1 may share at least a part of the transaction and the supplementary data 503 acquired by another participant having the access privilege by using some means, and register the shared data as the supplementary data 503. In this way, for example, even when it is impossible for a certain participant to directly acquire information on a transaction constituting a registrable condition of a transaction to be registered with the transfer-destination distributed ledger from the transfer-source node 31 when the data transfer device 1 uses the transaction-relation graph 504 as transaction-relation data, it is possible for the certain participant to get and use the information, as supplementary data 503, acquired by another participant who is capable of acquiring the information. As a result, it is possible for the certain participant to create an effective transaction-relation graph 504.

Hereinafter, description will be made on a procedure to transfer data to the transfer-destination ledger network 4 by the data transfer device 1 using the transaction-relation data and the supplementary data 503.

A certain data transfer device 1 is simply described as the data transfer device 1, and a data transfer device 1 other than the certain data transfer device 1 is described as the other data transfer device 1. The other data transfer device 1 is not limited to one data transfer device 1. Further, when names of elements included in a data transfer device 1 are described, they mean the elements included in the certain data transfer device 1.

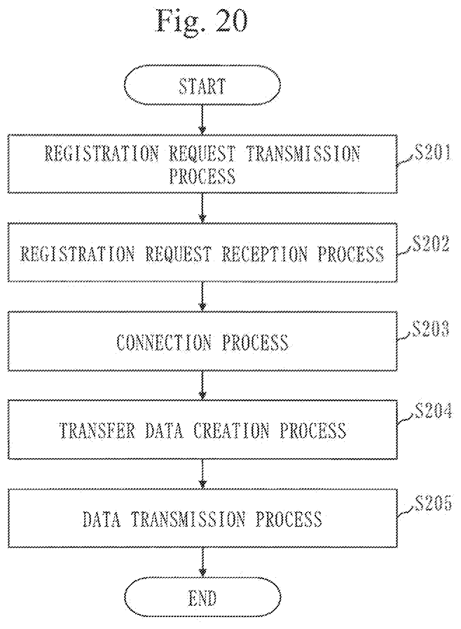

FIG. 20 is a flowchart illustrating an example of an operation of the data transfer system 90 according to the present embodiment. Description will be made on the operation of the data transfer system 90 with reference to the present diagram.

(Step S201: Registration Request Transmission Process)

The registration request unit 212 transmits a transfer-destination data registration request 509b to the data transfer device 1.

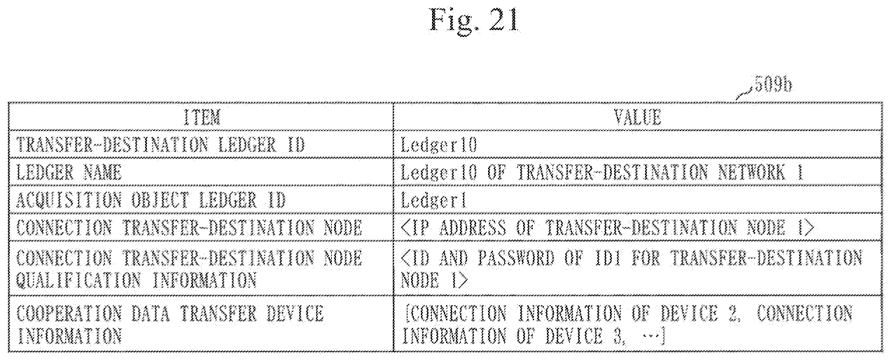

FIG. 21 illustrates an example of the transfer-destination data registration request 509b in the present embodiment. A main difference of the transfer-destination data registration request 509b with the transfer-destination data registration request 509 is that “cooperation data transfer device information” is added.

“Cooperation data transfer device information” is constituted by connection information of each of other data transfer devices 1 which the data transfer device 1 including the transfer-destination data registration request 509b cooperates with, and is also called cooperation data extraction/transfer device information. The connection information is information necessary to connect to the other data transfer devices 1 such as, for example, location information such as an ID address, etc., an ID and a password, or qualification information, etc. such as a secret key or a token, etc. of each of the other cooperating data transfer devices 1 to cooperate with. “Device 2”, etc. is a name of each of the other data transfer devices 1 to cooperate with.

(Step S202: Registration Request Reception Process)

The registration request reception unit 131 receives the transfer-destination data registration request 509b, and transmits the transfer-destination data registration request 509b received to the ledger update monitoring unit 15 and the data creation unit 132.

(Step S203: Connection Process)

The ledger update monitoring unit 15 is connected to the transfer-destination node 41 based on the information indicated in the transfer-destination data registration request 509b received, and monitors a status of transaction registration of the transfer-destination distributed ledger in the transfer-destination node 41 connected.

Further, the ledger update monitoring unit 15 is connected to the data transmission unit 133 of the other data transfer device 1 based on the information indicated in the transfer-destination data registration request 509b received, and starts receiving, from the data transmission unit 133 of the other data transfer device 1, information indicating the correspondence between a transaction ID corresponding to a transfer-source transaction transmitted by the data transmission unit 133, and a transaction ID newly set at the time when the transaction is registered with the transfer-destination distributed ledger.

(Step S204: Transfer Data Creation Process)

The data creation unit 132 creates transfer data 510 using the transfer-destination data registration request 509b received by the registration request reception unit 131, transaction-relation data recorded in the transaction-relation data record unit 122, and supplementary data 503 recorded in the supplementary data record unit 142, and suitably transmits the transfer data 510 to the data transmission unit 133.

Hereinafter, description will be made on creation and transmission of the transfer data 510 in a case wherein the data transfer device 1 adopts a transaction-relation graph 504 as transaction-relation data.

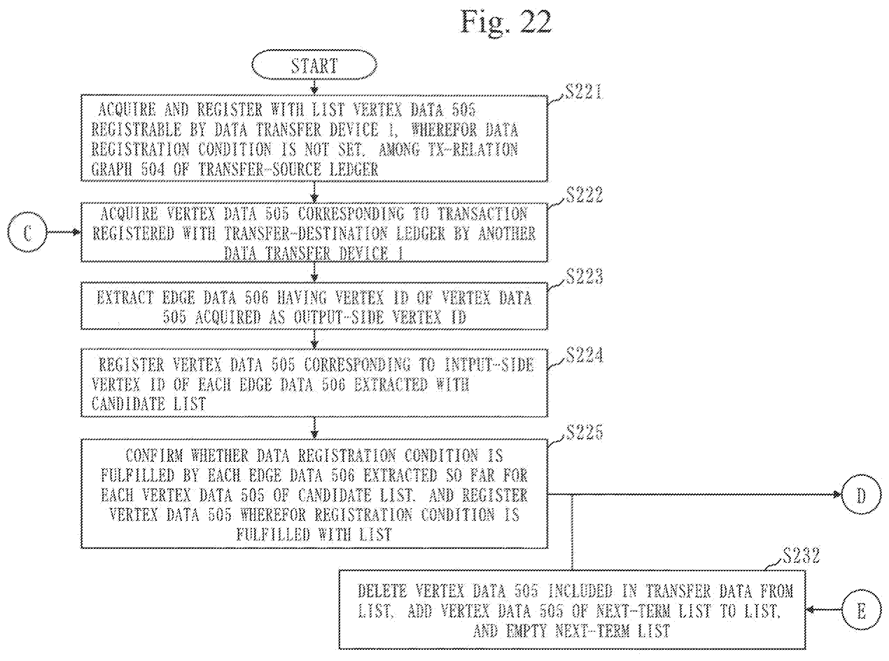

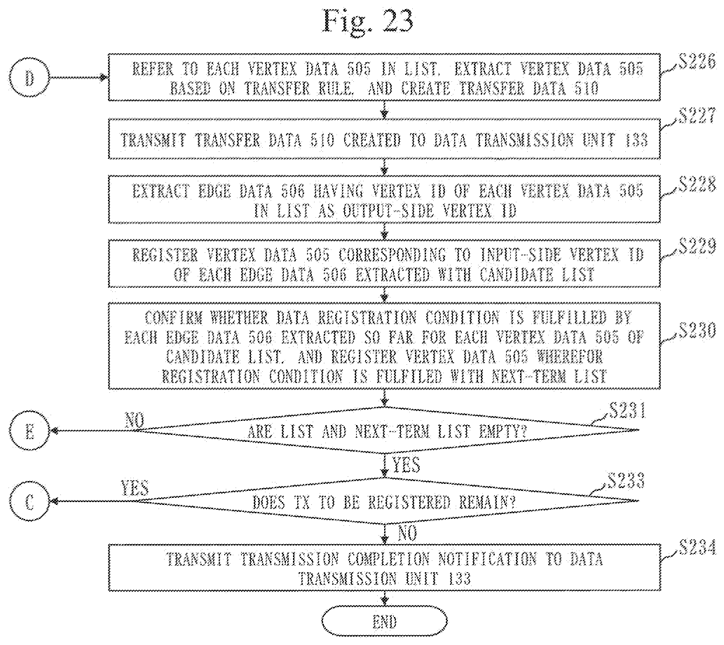

FIG. 22 and FIG. 23 are flowcharts illustrating an example of a process to create the transfer data 510, and a process to transmit the transfer data 510 created to the data transmission unit 133, by the data creation unit 132. With reference to these diagrams, description will be made on the process of the data creation unit 132. One flowchart is divided into FIG. 22 and FIG. 23.

(Step S221)

The data creation unit 132 acquires vertex data 505 which can be registered by the data transfer device 1, and for which a data registration condition is not set, among vertex data 505 corresponding to elements included in “vertex set” of the transaction-relation graph 504 related to the transfer-source distributed ledger, and registers the vertex data 505 acquired with the list. The data creation unit 132 acquires, from the transaction-relation data record unit 122, the transaction-relation graph 504 corresponding to the transfer-source distributed ledger, using “acquisition object ledger ID” of the transfer-destination data registration request 509b.

The data creation unit 132 decides, for example, whether it is possible for the data transfer device 1 to register certain vertex data 505 or not, based on whether “executor information” of the selected transaction data 502 corresponding to the certain vertex data 505 coincides with a possessor of the data transfer device 1. The data creation unit 132 regards that it is possible to register vertex data 505 when “executor information” coincides with the possessor. As another decision method, by setting correspondence between “executor information” of the selected transaction data 502 and the possessor of the data transfer device 1, even in a case wherein “executor information” does not coincide with the possessor, the data creation unit 132 may decide that it is possible for the data transfer device 1 to register the vertex data 505. Further, the data transfer device 1 may set a possessor who can register each transaction for each transaction, being the possessor of the data transfer device 1, as the supplementary data 503.

The vertex data 505, for which the data registration condition is not set, is vertex data 505 which is not set as “input-side vertex ID” of edge data 506 corresponding to edges included in “edge set” among vertex data 505 corresponding to vertexes included in “vertex set” of the transaction-relation graph 504.

(Step S222)

The data creation unit 132 acquires vertex data 505 corresponding to a transaction registered with the transfer-destination distributed ledger by the other data transfer device 1. The data creation unit 32 may acquire the vertex data 505 using the other device registration information.

As a specific example, the data creation unit 132 confirms, by inquiring the ledger update monitoring unit 15, whether there is a transaction registered with the transfer-destination distributed ledger from the time when an inquiry is made to the ledger update monitoring unit 15 last time by the time when an inquiry is made to the ledger update monitoring unit 15 this time. When there is the transaction, the data creation unit 132 makes the ledger update monitoring unit 15 return the vertex data 505 corresponding to the transaction. When there is no transaction concerned, the data creation unit 132 may wait until a transaction is registered, or may continue the process as it is by regarding that the transaction cannot be acquired. When the process is continued as it is, the data creation unit 132 skips the process from Step S223 to Step S225, and performs the process of Step S226.

(Step S223)

The data creation unit 132 extracts edge data 506 having “vertex ID” of each piece of vertex data 505 acquired in the process of Step S222 as “output-side vertex ID”.

(Step S224)

The data creation unit 132 registers the vertex data 505 corresponding to “input-side vertex ID” of each piece of the edge data 506 extracted with a candidate list. When certain vertex data 505 has already been registered with the candidate list, the data creation unit 132 does not register the certain vertex data 505 with the candidate list in an overlapped manner. The candidate list is a list of vertex data 505 for which at least a part of data registration conditions are fulfilled at the time of the process for elements included in the candidate list. The data registration condition of certain vertex data 505 is that all pieces of the edge data 506 having “vertex ID” of the certain vertex data 505 as “input-side vertex ID” are extracted by the process of Step S223 and Step S228 during iteration by the time when the process of the present step is performed.

(Step S225)

The data creation unit 132 confirms, with respect to each piece of vertex data 505 included in the candidate list, whether the data registration conditions are fulfilled or not by each piece of edge data 506 extracted after the data creation unit 132 starts the process indicated in the present flowchart by the time when the process of the present step is performed, and registers the vertex data 505 for which the data registration conditions are fulfilled with the list.

(Step S226)

The data creation unit 132 refers to each piece of vertex data 505 in the list, extracts vertex data 505 based on a transfer rule, and creates transfer data 510 using the vertex data 505 extracted. The transfer rule is equivalent to the transfer rule according to the first embodiment. The creation method of the transfer data 510 is equivalent to the creation method of the transfer data 510 according to the first embodiment.

When the list is empty, the data creation unit 132 skips the process from Step S226 to Step S230, and performs the process of Step S231.

(Step S227)

The data creation unit 132 transmits the transfer data 510 created to the data transmission unit 133.

(Step S228)

The data creation unit 132 extracts edge data 506 having “vertex ID” of each piece of vertex data 505 in the list as “output-side vertex ID”. The process of the present step is equivalent to the process of Step S223.

(Step S229)

The data creation unit 132 registers vertex data 505 corresponding to “input-side vertex ID” of each piece of the edge data 506 extracted with the candidate list. The process of the present step is equivalent to the process of Step S224.

(Step S230)

The data creation unit 132 confirms, with respect to each piece of the vertex data 505 included in the candidate list, whether the data registration conditions are fulfilled by each piece of the edge data 506 extracted after the data creation unit 132 starts the process of the present flowchart by the time when the process of the present step is performed, and registers the vertex data 505 for which the registration conditions are fulfilled with a next-term list. The next-term list is equivalent to the next-term list according to the first embodiment.

(Step S231)

The data creation unit 132 confirms whether the list and the next-term list are empty.

When the list and the next-term list are empty, the data creation unit 132 proceeds to step S233. In other cases, the data creation unit 132 proceeds to Step S232.

(Step S232)

The data creation unit 132 deletes the vertex data 505 included in the transfer data 510 from the list, adds the vertex data 505 included in the next-term list to the list, and empties the next-term list. Then, the data creation unit 132 proceeds to Step S226.

(Step S233)

The data creation unit 132 confirms whether transactions to be registered remain or not. The transactions to be registered are all transactions which can be registered by the data transfer device 1. The transactions which can be registered are as described in Step S221.

When the transactions to be registered remain, the data creation unit 132 performs the process of Step S222, and confirms whether any transaction for which the data registration conditions are fulfilled exists, by the other data transfer device 1. In other cases, the data creation unit 132 proceeds to Step S234.

(Step S234)

The data creation unit 132 transmits a transmission completion notification to the data transmission unit 133, and finishes the process of the present flowchart.

(Step S205: Data Transmission Process)

The data transmission unit 133 transfers data to the transfer-destination node 41 based on the transfer data 510 received from the data creation unit 132. Further, the data transmission unit 133 transmits a result of registering data in the transfer-destination node 41 to the ledger update monitoring unit 15 of the other data transfer device 1.

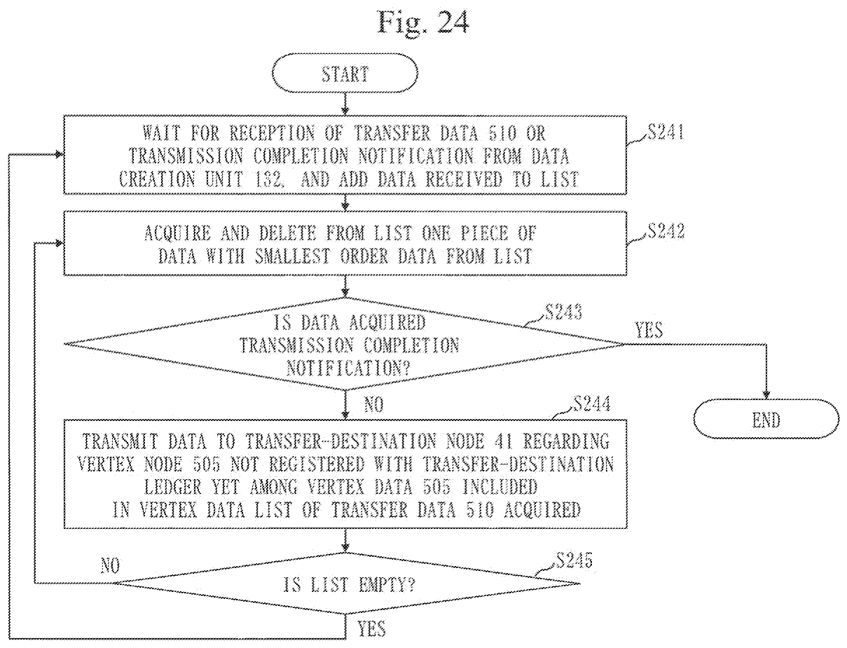

FIG. 24 is a flowchart illustrating an example of an operation to transmit data to the transfer-destination node 41 and the ledger update monitoring unit 15 of the other data transfer device by the data transmission unit 133. Description will be made on an operation of the data transmission unit 133 with reference to the present diagram. In the present example, it is assumed that numerical values are set as “order data” of the transfer data 510, and the data transmission unit 133 processes the transfer data 510 in an order from transfer data 510 having “order data” with a small value.

(Step S241)

The data transmission unit 133 adds the data received from the data creation unit 132 to the list. The process of the present step is equivalent to the process of Step S161.

(Step S242)

The data transmission unit 133 acquires data from the list. The process of the present step is equivalent to the process of Step S162.

(Step S243)

The data transmission unit 133 confirms whether the data acquired is the transmission completion notification or not.

When the data acquired is the transmission completion notification, the data transmission unit 133 finishes the process of the present flowchart. In other cases, that is, when the data acquired is the transfer data 510, the data transmission unit 133 proceeds to Step S244.

(Step S244)

The data transmission unit 133 transmits transfer data 510 to a transfer-destination node 41 corresponding to vertex data 505 corresponding to data that has not been registered yet with the transfer-destination distributed ledger among the vertex data 505 corresponding to elements included in “vertex data list” of the transfer data 510 acquired.

It is possible for the data transmission unit 133 to investigate, for example, whether data corresponding to certain vertex data 505 is registered with the transfer-destination distributed ledger by using the ledger update monitoring unit 15. Specifically, the data transmission unit 133 confirms whether “transaction ID” of vertex data 505 corresponding to elements included in “vertex data list” of the transfer data 510 acquired is registered as a registered transaction with information indicating a status of transaction registration managed by the ledger update monitoring unit 15, whereby it is possible to decide whether the vertex data 505 is vertex data 505 corresponding to the data registered with the transfer-destination distributed ledger or not. As another investigation method, there is a method to inquire the transfer-destination node 41 of whether it is possible to execute a transaction corresponding to the vertex data 505, by the data transmission unit 133. As a specific example, it is considered a case wherein a smart contract of a ledger being a data transfer object has a logic so as to decide whether data with the same content is being doubly registered, and when the data is to be doubly registered, to discard the transaction. In this case, first, the data transmission unit 133 transmits data corresponding to the vertex data 505 to the transfer-destination node 41. Next, the transfer-destination node 41 decides whether it is possible to register the data corresponding to the vertex data 505 by the smart contract. Next, when it is possible to register the data corresponding to the vertex data 505, the data transmission unit 133 decides that the data corresponding to the vertex data 505 has not been registered with the transfer-destination distributed ledger. Further, in this case, the data transmission unit 133 may adopt a method to register data with the transfer-destination node 41, not the method to inquire the transfer-destination node 41. In a case wherein the data transmission unit 133 adopts a method to register data, it is possible for the data transmission unit 133 to decide that the data has not been registered yet with the transfer-destination distributed ledger if it is possible to successfully register the data corresponding to the vertex data 505 with the transfer-destination node 41, and to decide that the data has already been registered with the transfer-destination distributed ledger if it is impossible to register the data with the transfer-destination node 41.

Description will be made on a specific example of a process to transmit data to the transfer-destination node 41 by the data transmission unit 133. First, the data transmission unit 133 is connected to the transfer-destination node 41 using at least any of “ledger name” of the transfer data 510, “connection-destination node” and “connection-destination node qualification information,” etc. Next, the data transmission unit 133 refers to any of selected transaction data 502 and supplementary data 503 corresponding to vertex data 505 corresponding to each element included in “vertex data list”. Next, the data transmission unit 133 may transmit a transaction to the transfer-destination node 41, or call functions of the transfer-destination node 41, in accordance with the data referred to. In this manner, data transmission to the transfer-destination distributed ledger is completed.

(Step S245)

The data transmission unit 133 confirms whether the list is empty or not.

When the list is empty, the data transmission unit 133 proceeds to Step S241. In other cases, the data transmission unit 133 proceeds to Step S242.

In the description of the operations described above, the data transfer object is all transactions included in the ledger being the transfer object of the transfer-source ledger network 3. However, the data transfer object may be a part of the transactions included in the ledger being the transfer object of the transfer-source ledger network 3. Since the process of the data transfer device 1 in this case is equivalent to that in the first embodiment, description of the process is omitted.

### Description of Effect of Second Embodiment

As described above, according to the present embodiment, the data transfer device 1 includes the ledger update monitoring unit 15, and further, a plurality of data transfer devices 1 operate in cooperation with each other. Therefore, the data transfer device 1 according to the present embodiment also includes the features of the first embodiment, and is also capable of transferring data when an acquisition privilege of a transaction being a transfer object included in the transfer-source ledger network 3 is set, or an privilege to register a transaction with the transfer-destination ledger network 4 is set, etc.

### Third Embodiment

Hereinafter, description will be made mainly of parts different from those in the embodiments described above, with reference to diagrams.

***Description of Configuration***

The data transfer device 1 according to the present embodiment has a function to confirm whether a transfer-destination distributed ledger generated by the embodiments described above is equivalent to a transfer-source distributed ledger. The present function may be combined with any embodiments; however, description will be made on a specific example wherein the present function is added to the first embodiment, for convenience of explanation. It is possible to perform the process according to the present embodiment after at least a part of electronic data recorded in the transfer-source distributed ledger is transferred to the transfer-destination distributed ledger.

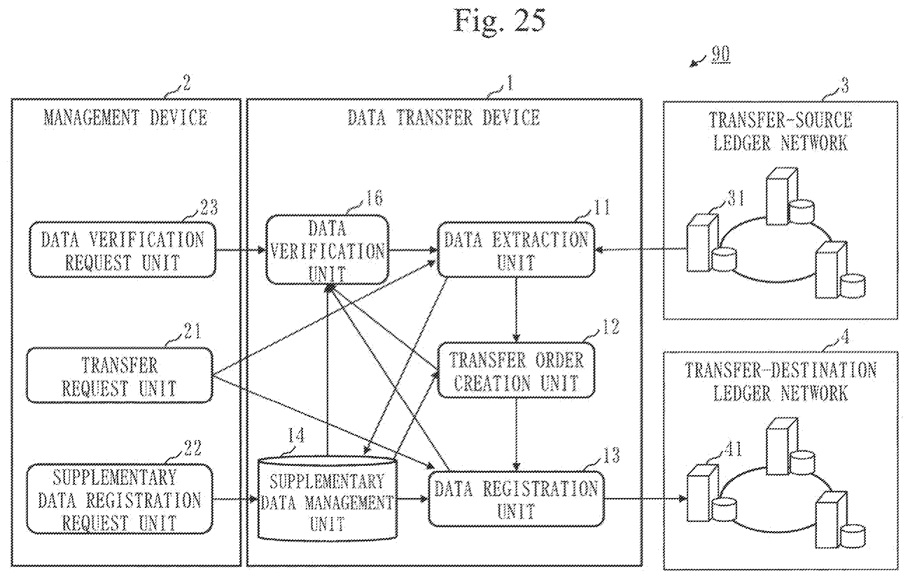

FIG. 25 illustrates a configuration example of the data transfer system 90 according to the present embodiment. Main differences of the present embodiment with the first embodiment are that the data transfer device 1 includes a data verification unit 16, and the management device 2 includes a data verification request unit 23.

The data acquisition unit 112 acquires, from the transfer-destination distributed ledger, transfer-destination acquisition data including transfer-destination data being data corresponding to each element of transfer-destination transfer data based on the data verification request 511. The data verification request 511 is a request to verify identity between the transfer-source distributed ledger and the transfer-destination distributed ledger. The transfer-destination transfer data is equivalent to the transfer data 510. The transfer-destination acquisition data is equivalent to the acquisition data. The transfer-destination data is equivalent to the data corresponding to the creation element. The transfer-destination transfer data is data corresponding to at least a part of the transfer data 510.

The data selection unit 113 selects and extracts the transfer-destination data from the transfer-destination acquisition data.

The transaction-relation data creation unit 121 may create transfer-destination transaction-relation data using the transfer-destination data as needed when there is no supplementary data 503 corresponding to any of the transfer-destination data. Further, when there is supplementary data 503 corresponding to each of at least any of the transfer-destination data, the transaction-relation data creation unit 121 may create transfer-destination transaction-relation data using the transfer-destination data, and the supplementary data 503 corresponding to each of at least any of the transfer-destination data, as needed. The transfer-destination transaction-relation data corresponds to relation data for comparison being at least a part of the transaction-relation data. The relation data for comparison corresponds to electronic data which has been transferred to the transfer-destination distributed ledger so far. When all pieces of the electronic data to be transferred are transferred to the transfer-destination distributed ledger, the relation data for comparison is the transaction-relation data.

The data verification unit 16 verifies whether a difference exists between the transfer-source distributed ledger and the transfer-destination distributed ledger. As a specific example, the data verification unit 16 receives the data verification request 511 from the management device 2, and performs comparison between the transfer-source distributed ledger which is regarded the transfer object by the data transfer device 1 including the data verification unit 16, and the transfer-destination distributed ledger, using each piece of transaction-relation data of the transfer-source distributed ledger and the transfer-destination distributed ledger, and the supplementary data 503. The data verification unit 16 uses data managed by the transfer order creation unit 12 and the supplementary data management unit 14, respectively as the transaction-relation data of the ledger and the supplementary data 503. When necessary data does not exist in any of the transfer order creation unit 12 and the supplementary data management unit 14, the data verification unit 16 suitably transmits an acquisition request to the data extraction unit 11, and requests acquisition of necessary data from the ledger. The data verification unit 16 verifies identity between the transfer-source distributed ledger and the transfer-destination distributed ledger, by comparing the relation data for comparison and the transfer-destination transaction-relation data.

The data verification request unit 23 transmits a data verification request 511 to the data transfer device 1.

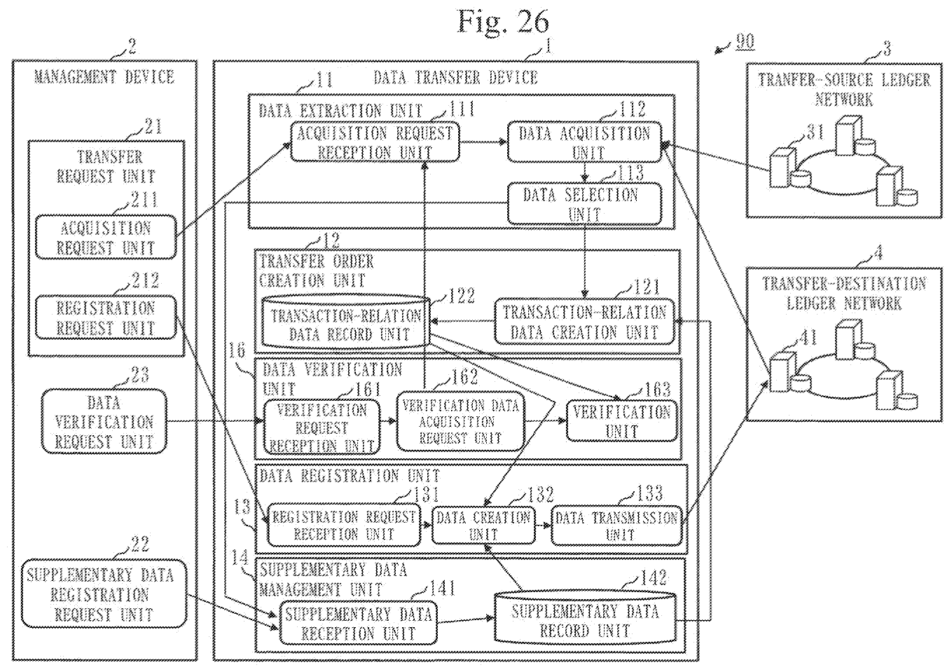

FIG. 26 illustrates a configuration example of software of each device included in the data transfer system 90 according to the present embodiment. Main differences of the present embodiment with the first embodiment are that the data transfer device 1 includes the data verification unit 16, and the management device 2 includes the data verification request unit 23.

The data verification unit 16 includes a verification request reception unit 161, a verification data acquisition request unit 162 and a verification unit 163.

The verification request reception unit 161 receives a data verification request 511 form the data verification request unit 23.

The verification data acquisition request unit 162 receives the data verification request 511 from the verification request reception unit 161, and confirms the contents of the data verification request 511 received. When at least any of transaction-relation data of a ledger being a comparison object and related supplementary data 503 is not created, the verification data acquisition request unit 162 requests the acquisition request reception unit 111, acquires data from a node retaining the ledger, and creates at least any of the transaction-relation data and the related supplementary data using the data acquired.

The verification unit 163 verifies whether each ledger coincides with each other by comparing each ledger being a comparison object indicated in the data verification request 511 by using transaction-relation data and related supplementary data 503 of each ledger, in accordance with a comparison method indicated in the data verification request 511.

***Description of Operation***

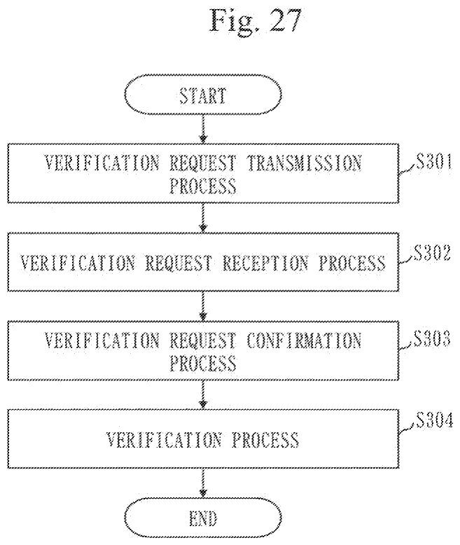

FIG. 27 is a flowchart illustrating an example of an operation of the data transfer system 90 according to the present embodiment. Description will be made on an operation of the data transfer system 90 with reference to the present diagram.

(Step S301: Verification Request Transmission Process)

The data verification request unit 23 transmits the data verification request 511 to the data transfer device 1.

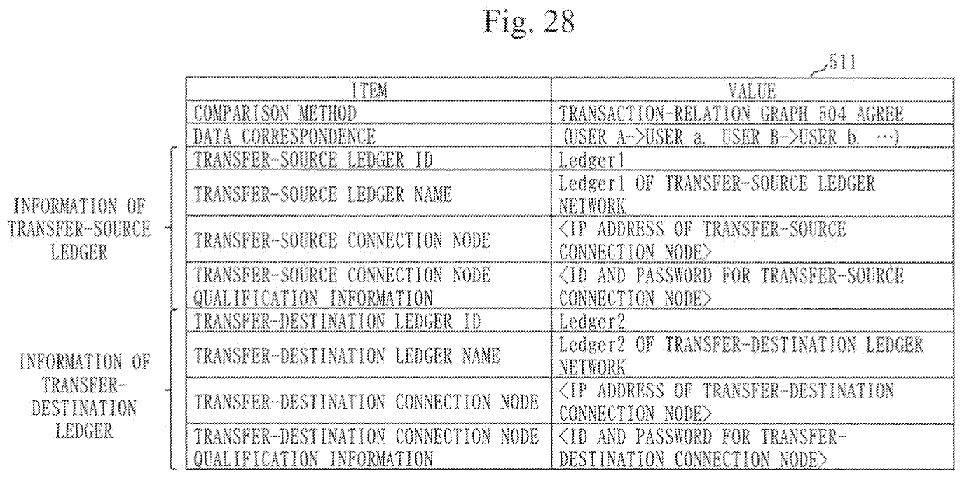

FIG. 28 illustrates a specific example of the data verification request 511. The data verification request 511 includes “comparison method”, “data correspondence” and “comparison object ledger information” indicating information of each ledger being a comparison object. Further, each piece of “comparison object ledger information” includes “comparison object ledger ID”, “comparison object ledger name”, “connection node” and “connection node qualification information”. “Comparison object ledger ID” is a general term of “transfer-source ledger ID” and “transfer-destination ledger name”. “Comparison object ledger name” is a general term of “transfer-source connection node” and “transfer-destination connection node”. “Connection node” is a general term of “transfer-source connection node” and “transfer-destination connection node”. “Connection node qualification information” is a general term of “transfer-source connection node qualification information” and “transfer-destination connection node qualification information”.

“Comparison method” is information to indicate a rule to define a method to compare a ledger being a comparison object. As an example of the rule, comparing transaction-relation data is considered. In the present example, the rule is to regard that ledgers being comparison objects coincide with each other when transaction data and transaction-relation data representing relation between transaction data, which are extracted from each ledger being the comparison object, are logically the same contents.

“Data correspondence” is to concretely collect cases wherein when values of a certain item differ between the ledgers being comparison objects, the contents represented by the values of the certain item coincide with each other. As a specific example, there is a case wherein an executor of data registration is changed at the transfer-destination distributed ledger. In this case, when values of the executors of data registration are used, it may be decided that the content of the transfer-source distributed ledger does not coincide with the content of the transfer-destination distributed ledger by “comparison method”. However, by describing that these executors coincide in “data correspondence”, it is possible for the data verification unit 16 to regard these executors agree; therefore, it is possible to regard that the contents coincide between the ledgers being the comparison objects. As a specific example of “data correspondence”, information representing users such that a user A of a ledger 1 and a user B of a ledger 2 are the same user, etc., or information indicating an execution order, etc. are considered. Transaction IDs are also information typically having different values between the transfer-source distributed ledger and the transfer-destination distributed ledger. As for the transaction IDs, when data transfer is transferred, the data transmission unit 133 or the ledger update monitoring unit 15, etc. may retain correspondence of the transaction IDs before and after data transfer, or the data verification unit 16 may use correspondence of the transaction IDs retained.

“Ledger ID” is an identifier to uniquely represent each ledger being a comparison object.

“Comparison object ledger name” is a name set in the ledger being the comparison object.

“Connection node” is information representing locations of nodes to connect in acquiring data from the ledger, and is equivalent to “connection transfer-source node”, etc.

“Connection node qualification information” is information used in a case wherein authentication is required in connecting “connection node,” and is equivalent to “connection transfer-source node qualification information”, etc.

Among “comparison object ledger information”, “comparison object ledger name”, “connection node” and “connection node qualification information” may not exist when transaction-relation data representing a ledger indicated by “comparison object ledger ID” corresponding to them is stored in the transaction-relation data record unit 122.

(Step S302: Verification Request Reception Process)

The verification request reception unit 161 receives the data verification request 511 from the management device 2, and transmits the data verification request 511 received to the verification data acquisition request unit 162.

(Step S303: Verification Request Confirmation Process)

The verification data acquisition request unit 162 receives the data verification request 511 from the verification request reception unit 161, and confirms contents of the data verification request 511 received.

As a specific example, the verification data acquisition request unit 162 extracts each “comparison object ledger ID,” and confirms whether transaction-relation data representing a ledger indicated by each “comparison object ledger ID” extracted is stored in the transaction-relation data record unit 122 or not. The verification data acquisition request unit 162 confirms, for example, whether the transaction-relation graph 504 having “acquisition object ledger ID” with the same value as “comparison object ledger ID” is stored in a case wherein the data transfer device 1 uses the transaction-relation graph 504 as the transaction-relation data. When the transaction-relation graph 504 is entirely stored, the verification data acquisition request unit 162 transmits the data verification request 511 to the verification unit 163. As for a comparison object ledger wherein transaction-relation data is not stored, the data extraction unit 11 and the transfer order creation unit 12 create transaction-relation data corresponding to the comparison object ledger. As a specific example, the verification data acquisition request unit 162 first creates a transfer-source data acquisition request 501 using data, which are included in the data verification request 511, and which indicates each of “comparison object ledger ID”, “comparison object ledger name”, “connection node” and “connection node qualification information” corresponding to the comparison object ledger being a comparison object ledger desired to acquire. Next, the verification data acquisition request unit 162 makes the data extraction unit 11 and the transfer order creation unit 12 create transaction-relation data corresponding to the comparison object ledger desired to acquire, by transmitting the transfer-source data acquisition request 501 created to the acquisition request reception unit 111. The transaction-relation data created is transfer-destination transaction-relation data. Next, the verification data acquisition request unit 162 confirms that the transaction-relation data corresponding to “comparison object ledger information” included in the data verification request 511, and transmits the data verification request 511 to the verification unit 163.

(Step S304: Verification Process)

The verification unit 163 receives the data verification request 511 from the verification data acquisition request unit 162, and starts verification of a ledger being a comparison object.

As a specific example, the verification unit 163 confirms by what rule ledgers being comparison objects are compared, by confirming “comparison method” in the data verification request 511 first. Next, the verification unit 163 compares the transaction-relation data corresponding to a ledger being each comparison object and related supplementary data 503 in accordance with “comparison method”.

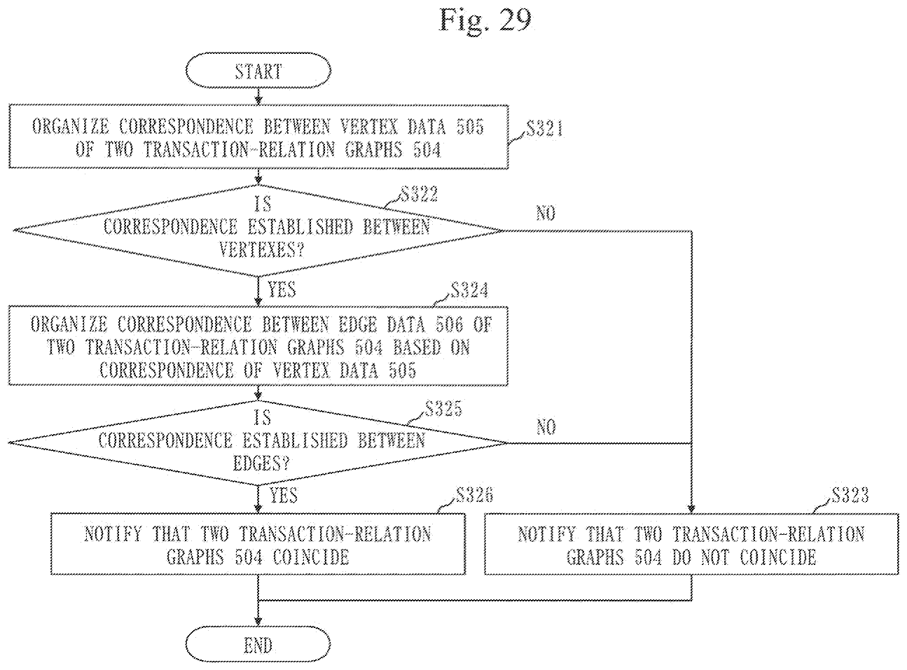

FIG. 29 is a flowchart illustrating an example of a process to compare the transfer-source distributed ledger and the transfer-destination distributed ledger by the verification unit 163 in a case wherein the data transfer device 1 uses the transaction-relation graph 504 as transaction-relation data, and a verification method is coincidence of the transaction-relation graph 504. Description will be made on an operation of the verification unit 163 with reference to the present diagram.

(Step S321)

The verification unit 163 organizes correspondence between vertex data 505 corresponding to elements included in “vertex set” included in each transaction-relation graph 504 of the transfer-source distributed ledger and the transfer-destination distributed ledger.

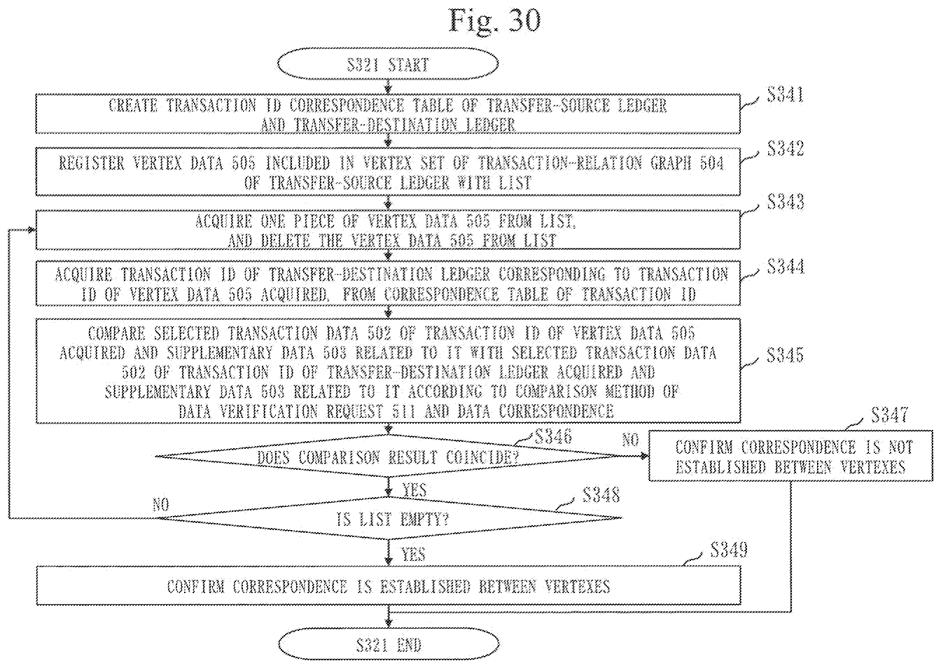

FIG. 30 is a flowchart illustrating an example of a detailed process of Step S321. Description will be made on a detailed process of Step S321 with reference to the present diagram.

(Step S341)

The verification unit 163 creates a transaction ID correspondence table indicating correspondence between transaction IDs in the transfer-source distributed ledger and transaction IDs in the transfer-destination distributed ledger.

As a specific example, in the configuration of the second embodiment, the ledger update monitoring unit 15 stores information indicating correspondence between transaction IDs of transfer-source transactions, and transaction IDs newly set in registering the transfer-source transactions in a transfer destination. Therefore, the verification unit 163 may create the transaction ID correspondence table by using information stored in the ledger update monitoring unit 15. Further, in the configuration of the first embodiment, the data transmission unit 133 may acquire transaction IDs of transfer-destination transactions registered with the transfer-destination distributed ledger, and may store information associating the transaction IDs acquired with the transaction IDs of transfer-source transactions. In this case, the verification unit 163 may create a transaction ID correspondence table by using information stored in the data transmission unit 133.

(Step S342)

The verification unit 163 registers vertex data 505 corresponding to elements included in “vertex set” of the transaction-relation graph 504 corresponding to the transfer-source distributed ledger, with the list.

(Step S343)

The verification unit 163 acquires one piece of the vertex data 505 from the list, and deletes the vertex data 505 acquired from the list.

(Step S344)

The verification unit 163 refers to the transaction ID correspondence table, and acquires a transaction ID of the transfer-destination distributed ledger corresponding to “transaction ID” of the vertex data 505 acquired.

(Step S345)

The verification unit 163 compares selected transaction data 502 corresponding to “transaction ID” of the vertex data 505 acquired, supplementary data 503 related to the selected transaction data 502, selected transaction data 502 corresponding to a transaction ID in the transfer-destination distributed ledger acquired, and supplementary data 503 related to the selected transaction data 502, in accordance with “comparison method” and “data correspondence” of the data verification request 511.

(Step S346)

The verification unit 163 confirms whether contents of the transfer-source transaction coincide with contents of the transfer-destination transaction corresponding to the transfer-source transaction or not, as a result of comparison in Step S345.

When both contents coincide with each other, the verification unit 163 proceeds to Step S348. In other cases, the verification unit 163 proceeds to Step S347.

(Step S347)

By considering that it is confirmed the correspondence between vertexes is not established between ledgers being comparison objects, the verification unit 163 finishes the process of the present flowchart.

(Step S348)

The verification unit 163 confirms whether the list is empty or not.

When the list is empty, the verification unit 163 proceeds to Step S349. In other cases, the verification unit 163 returns to Step S343.

(Step S349)

By considering that it is confirmed the correspondence between vertexes is established between ledgers being comparison objects, the verification unit 163 finishes the process of the present flowchart.

(Step S322)

Upon receipt of the result of the process in Step S321, the verification unit 163 confirms whether the correspondence between vertexes is established between the transfer-source distributed ledger and the transfer-destination distributed ledger or not. When the correspondence between the vertexes is established, the verification unit 163 proceeds to Step S324. In other cases, the verification unit 163 proceeds to Step S323.

(Step S323)

The verification unit 163 notifies that transaction-relation graphs 504 corresponding to each of the transfer-source distributed ledger and the transfer-destination distributed ledger do not coincide with each other, and finishes the process of the present flowchart.

(Step S324)

The verification unit 163 organizes the correspondence between edge data 506 corresponding to elements of “edge set” included in each transaction-relation graph 504 of the transfer-source distributed ledger and the transfer-destination distributed ledger, based on the correspondence between the vertex data 505.

As a specific example, it is assumed that a transaction-relation graph 504 corresponding to the transfer-source distributed ledger is G((v1(1234), v2(2345)), (e1(v1, v2))), a transaction-relation graph 504 corresponding to the transfer-destination distributed ledger is G((v9(9876), v8(8765)), (e9(v9, v8))), and a transaction ID correspondence table is ((1234≥9876)). (2345≥8765)), v1(1234) indicates vertex data 505 with “transaction ID” 1234, and “vertex ID” v1, e1(v1, v2) indicates edge data 506 with “edge ID” e1, “output-side vertex ID” v1, and “input-side vertex ID” v2. G(V, E) indicates a transaction-relation graph 504 constituted by a vertex set V and an edge set E. (1234≥9876) indicates that a transaction having a transaction ID 1234 in the transfer-source distributed ledger and a transaction having a transaction ID 9876 in the transfer-destination distributed ledger correspond to each other. In this case, it is recognized from the transaction ID correspondence table that as for the vertex data 505, correspondence is established between each of v1 and v9, and v2 and v8. Thus, by considering the correspondence between the transactions, e9(v9, v8) can be replaced with e9(v1, v2), and according to this, it is recognized that e1 (v1, v2) and e9(v9, v8) are edges between which correspondence is established. In this manner, the verification unit 163 organizes edge data 506 corresponding to each of all the elements in “edge set” of the transaction-relation graphs 504 corresponding to each of the transfer-source distributed ledger and the transfer-destination distributed ledger on whether correspondence is established or not.

(Step S325)

The verification unit 163 confirms whether correspondence is established between the transfer-source distributed ledger and the transfer-destination distributed ledger as for all pieces of the edge data 506.

When the correspondence is established with respect to all pieces of the edge data 506, the verification unit 163 proceeds to Step S326. In other cases, the verification unit 163 proceeds to Step S323.

(Step S326)

The verification unit 163 notifies that the transaction-relation graphs 504 coincide with each other between the transfer-source distributed ledger and the transfer-destination distributed ledger, and finishes the process of the present flowchart.

### Description of Effect of Third Embodiment

As described above, according to the present embodiment, since the data transfer device 1 includes the data verification unit 16, it is possible to verify whether data transferred in a transfer-destination distributed ledger coincides with original data in a transfer-source distributed ledger, while remaining the features included in the embodiments as described above.

### Fourth Embodiment

Hereinafter, description will be made on points different from those in the embodiments as described above, with reference to diagrams.

***Description of Configuration***

The data extraction unit 11 and the data registration unit 13 may extract and transfer data from a data store other than distributed ledgers. The data store is assumed to be capable of at least one of registering and referring to a format of transaction data of distributed ledgers. The data store is a general term of the transfer-source data store 5 and the transfer-destination data store 6, as well.

The data store may be added to the configuration of any of the other embodiments; however, hereinafter, description will be made on a specific example in a case wherein the data store is added to the first embodiment for convenience of explanation.

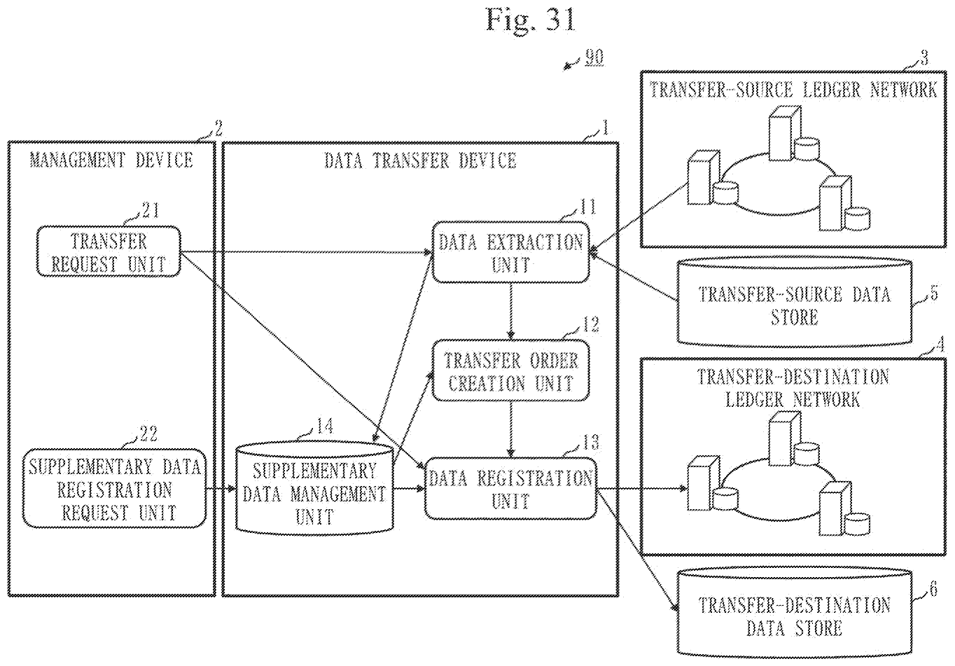

FIG. 31 illustrates a configuration example of the data transfer system 90 according to the present embodiment. Main differences of the present embodiment with the first embodiment are that the data extraction unit 11 is connected not only to the transfer-source ledger network 3, but also to the transfer-source data store 5, and that the data registration unit 13 is connected not only to the transfer-destination distributed network 4 but also to the transfer-destination data store 6. The transfer-source data store 5 is also called a transfer-source transaction-format data store. The transfer-destination data store 6 is also called a transfer-destination transaction-format data store.

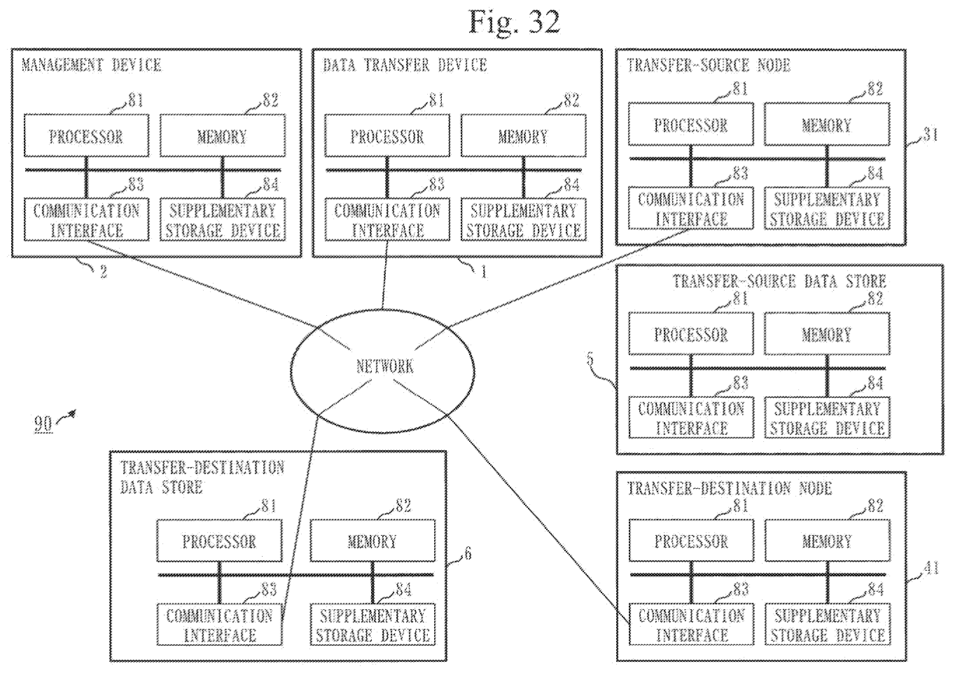

FIG. 32 illustrates a configuration example of hardware of each device included in the data transfer system 90 according to the present embodiment. A main difference of the present embodiment with the first embodiment is that the data transfer system 90 includes the transfer-source data store 5 and the transfer-destination data store 6.

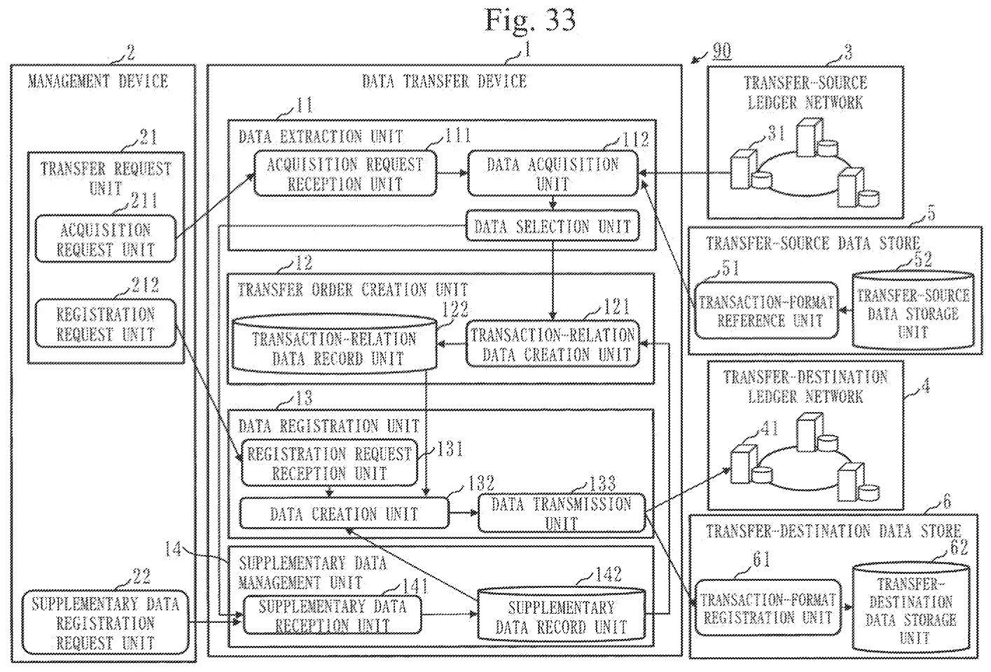

FIG. 33 illustrates a configuration example of software of each device included in the data transfer system 90. A main difference of the present embodiment with the first embodiment is that the data transfer system 90 includes the transfer-source data store 5 and the transfer-destination data store 6.

The data acquisition unit 112 is assumed to be capable of connecting to the transfer-source data store 5 using at least any of “acquisition object ledger ID”, “acquisition object ledger name”, “connection transfer-source node” and “connection transfer-source node qualification information”, etc. The data acquisition unit 112 may acquire data including acquisition data from a data store that records the same data as the data recorded in the transfer-source distributed ledger instead of the transfer-source distributed ledger, based on the transfer request.

The transfer-source data store 5 includes a transaction-format reference unit 51 and a transfer-source data storage unit 52.

The transaction-format reference unit 51 receives a data acquisition request based on the transfer-source data acquisition request 501 transmitted by the data acquisition unit 112, refers to and converts the data stored in the transfer-source data storage unit 52 appropriately, and transmits the data referred to and converted appropriately to the data acquisition unit 112.

The transfer-source data storage unit 52 is a data store to retain a record of registering, updating, and referring to data in accordance with a data process request from applications so far, and is a data store to also retain execution history data corresponding to the data process request in addition to the latest data. Further, in addition, the transfer-source data storage unit 52 is assumed to store a main body of a smart contract having functions equivalent to those of an application which has registered data, event data in building an application and associating the application with the transfer-source data storage unit 52, and event data of modifying a logic of an application, and be suitably called in response to a reference request from the transaction-format reference unit 51.

The transfer-source data store 5 may adopt a centralized ledger system. In this case, as a specific example, in the transaction-format reference unit 51, the same smart contract as in the transfer-source distributed ledger operates, and the transfer-source data storage unit 52 records a transaction and supplementary data 503 corresponding to the smart contract operating.

The data transmission unit 133 is assumed to be capable of connecting to the transfer-destination data store 6 using at least any of “ledger name”, “connection transfer-destination node” and “connection transfer-destination node qualification information”, etc. of the transfer data 510. The data transmission unit 133 may transmit data corresponding to each creation element to a data store that is capable of processing data corresponding to each of the creation elements instead of the transfer-destination distributed ledger.

The transfer-destination data store 6 includes a transaction-format registration unit 61 and a transfer-destination data storage unit 62.

The transaction-format registration unit 61 receives data based on the transfer data 510 transmitted by the data transmission unit 133, interprets the data received, and transfers data to be registered to the transfer-destination data storage unit 62 appropriately.

The transaction-format registration unit 61 is assumed to include an application capable of performing a process equivalent to that of the smart contract specified.

When there is a data registration request or a data reference request from the transaction-format registration unit 61, the transfer-destination data storage unit 62 registers data appropriately, and refers to data appropriately.

The transfer-destination data store may adopt a centralized ledger system. In this case, as a specific example, the same smart contract as in the transfer-destination distributed ledger operates in the transaction-format registration unit 61, and the transfer-destination data storage unit 62 records a transaction and supplementary data 503 corresponding to the smart contract operating.

***Description of Operation***

Hereinafter, description will be made mainly on differences with the first embodiment regarding an operation of the data acquisition unit 112 and an operation of the data transmission unit 133.

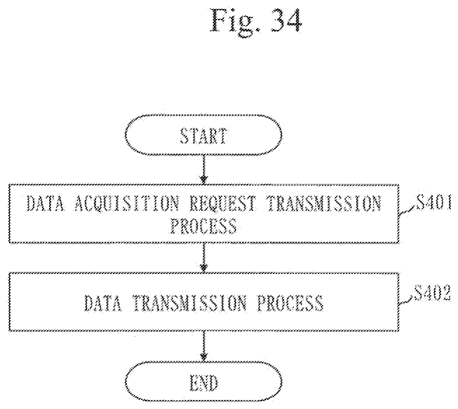

FIG. 34 is a flowchart illustrating an example of the operation of the data acquisition unit 112 according to the present embodiment. Description will be made on the operation of the data acquisition unit 112 with reference to the present diagram.

(Step S401: Data Acquisition Request Transmission Process)

The data acquisition unit 112 uses “connection transfer-source node” and “connection transfer-source node qualification information” of the transfer-source data acquisition request 501, and connects to the transfer-source node 31 or the transfer-source data store 5. A process in a case wherein the data acquisition unit 112 connects to the transfer-source node 31 is omitted since the process is the same as the process in the first embodiment. When the data acquisition unit 112 connects to the transfer-source data store 5, the data acquisition unit 112 transmits a data acquisition request including “acquisition object ledger ID” and “acquisition object ledger name” of the transfer-source data acquisition request 501 to the transfer-source data store 5.

(Step S402: Data Transmission Process)

The transaction-format reference unit 51 receives the data acquisition request transmitted by the data acquisition unit 112, uses “acquisition object ledger ID” and “acquisition object ledger name” included in the data acquisition request received, and acquires, from the transfer-source data storage unit 52, transaction corresponding data and supplementary data 503 related to a ledger corresponding to the data acquisition request. The transaction corresponding data is data which corresponds to a transaction. The transaction-format reference unit 51 converts the data acquired into a data format equivalent to a data format in which the transfer-source node 31 makes transmission to the data acquisition unit 112, and transmits the data converted to the data acquisition unit 112. The equivalent data format concerned is, for example, data indicating contents whereby it is possible for the data selection unit 113 to create the selected transaction data 502 and the supplementary data 503.

As a specific example, by regarding an application which registers data with the transfer-source data storage unit 52 as a smart contract, and a data process request from the application to the transfer-source data storage unit 52 as one transaction, the process of the transfer-source data store 5 can be considered as a process equivalent to an operation of the distributed ledger. In this case, it is assumed that in the process in response to the data process request from the application to the transfer-source data storage unit 52, a certain series of processes of data reference, data registration or data update are performed consistently by using a transaction function, etc. of the transfer-source data store 5. Further, a transaction to deploy a smart contract to the distributed ledger is event data in building an application, and associating the application with the transfer-source data storage unit 52. A transaction to update the smart contract in the distributed ledger corresponds to event data in modifying a logic of the application.

Description will be made on a specific example of a specific correspondence between data transmitted to the data acquisition unit 112 by the transaction-format reference unit 51 and the selected transaction data 502.

First, description will be made on an example of correspondence between data related to execution of the application, and selected transaction data 502 among data transmitted to the data acquisition unit 112 by the transaction-format reference unit 51. The transaction-format reference unit 51 uses a unique value assigned to each application as “acquisition object ledger ID” of the selected transaction data 502, and uses an ID of a data process request to the transfer-source data storage unit 52 from an application as “transaction ID” of the selected transaction data 502. The transaction-format reference unit 51 uses execution order information indicated in the data process request to the transfer-source data storage unit 52 from the application as “execution order information” of the selected transaction data 502. It is assumed that numbers are assigned to the execution order information of the data process request from the application to the transfer-source data storage unit 52, in the order from a data process request and an event having an older application order, by confirming beforehand a log of the data process request from the application to the transfer-source data storage unit 52, events of application building and association with the application, and an update event of the application. The transaction-format reference unit 51 sets “smart contract execution” to “type” of the selected transaction data 502, and uses a name of the application as “execution object” of the selected transaction data 502. The transaction-format reference unit 51 uses the process name inside the application when the data process request is made from the application to the transfer-source data storage unit 52, as “execution process” of the selected transaction data 502. The transaction-format reference unit 51 uses argument data passed to the transfer-source data storage unit 52 when the data process request is made from the application to the transfer-source data storage unit 52 as “process argument list” of the selected transaction data 502. The transaction-format reference unit 51 uses information on an owner or an executor of the application as “executor information” of the selected transaction data 502, and sets information on reference to and writing into the data store performed during the data process request as “execution result” of the selected transaction data 502.

Next, description will be made on a specific example of correspondence between data related to application building, and the selected transaction data 502 and the supplementary data 503 among data transmitted from the transaction-format reference unit 51 to the data acquisition unit 11. The transaction-format reference unit 51 uses a unique value assigned to each application as “acquisition object ledger ID” of the selected transaction data 502, and sets an ID of the event data in building the application and associating the application with the transfer-source data storage unit 52, the ID being not overlapped with another transaction ID, as “transaction ID” of the selected transaction data 502. The transaction-format reference unit 51 uses information on the execution order of the event data in building the application and associating the application with the transfer-source data storage unit 52, as “execution order information” of the selected transaction data 502, and sets “smart contract deployment” to “type” of the selected transaction data 502. In registering initial data used by the application with the transfer-source data storage unit 52, etc., the transaction-format reference unit 51 arbitrarily sets “execution object”, “execution process” and “process argument list” of the selected transaction data 502 in a manner equivalent to the process as described in the correspondence between the data related to execution of the application and the selected transaction data 502. Specifically, the transaction-format reference unit 51 uses the name of the application as “execution object”, uses the event name, etc. of the event data in building the application and associating the application with the transfer-source data storage unit 52 or the event data in modifying the logic of the application as “execution process”, and uses a main body, etc. of the event data in building the application and associating the application with the transfer-source data storage unit 52, or the event data in modifying the logic of the application as “process argument list”. The transaction-format reference unit 51 uses the information indicating the owner of the application or the executor of application building as “executor information” of the selected transaction data 502, and arbitrarily sets information on reference to and writing into the transfer-source data store 5 in registering the initial data, etc. as “execution result” of the selected transaction data 502. As for the supplementary data 503 related to the selected transaction data 502, the transaction-format reference unit 51 sets a value so as not to overlap the other supplementary data ID to “supplementary data ID”, sets the same value to each of the acquisition object ledger ID and the transaction ID set in the selected transaction data 502 related to “acquisition object ledger ID” and “transaction ID”, sets “smart contract” to “data type”, and sets a main body of a smart contract having a function equivalent to that of the application which registers the data, the application is stored in the transfer-source data storage unit 52, to “data”.

Next, description will be made on a specific example of correspondence between data related to update of the application, and the selected transaction data 502 and the supplementary data 503, among data transmitted to the data acquisition unit 112 by the transaction-format reference unit 51. Since the correspondence is similar to the correspondence between the data related to building of the application, and the selected transaction data 502 and the supplementary data 503, description will be made only on points different from those of the correspondence concerned.

The transaction-format reference unit 51 sets “smart contract update” to “type” of the selected transaction data 502, and arbitrarily sets “execution object”. “execution process” and “process argument list” of the selected transaction data 502 in a manner equivalent to the process as described in the correspondence between the data related to execution of the application, and the selected transaction data 502, in a case wherein conversion of existent data is necessary due to update of the application, etc. The transaction-format reference unit 51 arbitrarily set information indicating reference to and writing into the transfer-source data store 5 in performing conversion, etc. of the existent data due to application update, to “execution result” of the selected transaction data 502.

According to the processes described above, it is possible for the transaction-format reference unit 51 to convert a general application and an execution record of the transfer-source data store 5 into a data format equivalent to that of the transfer-source node 31.

The transaction-format reference unit 51 transmits the data which is converted into the data format equivalent to that of the transfer-source node 31, to the data acquisition unit 112.

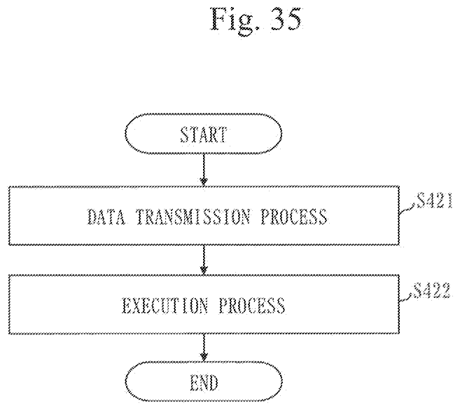

FIG. 35 is a flowchart illustrating an example of an operation of the data transmission unit 133 according to the present embodiment. Description will be made on an operation of the data transmission unit 133 with reference to the present diagram.

(Step S421: Data Transmission Process)

The data transmission unit 133 receives the transfer data 510 created by the data creation unit 132, uses “connection transfer-destination node” and “connection transfer-destination node qualification information” of the transfer data 510 received, and arbitrarily connects to the transfer-destination node 41 or the transfer-destination data store 6. Since the process in connecting to the transfer-destination node 41 by the data transmission unit 133 is equivalent to the process in the first embodiment, the description is omitted. When the data transmission unit 133 is connected to the transfer-destination data store 6, the data transmission unit 133 transfers data based on the transfer data 510 to the transfer-destination data store 6.

(Step S422: Execution Process)

The transaction-format registration unit 61 receives data from the data transmission unit 133, arbitrarily performs a process included in the data received, and records a result of the process in the transfer-destination data storage unit 62. Description will be made by assuming that, from the data transmission unit 133, “vertex data list” of the transfer data 510, each piece of the vertex data 505 corresponding to the elements included in “vertex data list”, the selected transaction data 502 corresponding to each piece of the vertex data 505, and the supplementary data 503 related to the selected transaction data 502 are transmitted.

As a specific example, first, it is considered a case wherein “type” of the selected transaction data 502 corresponding to vertex data 505 corresponding to a certain element included in “vertex data list” is “smart contract deployment” or “smart contract update”. In this case, the transaction-format registration unit 61 acquires a main body of the smart contract of the supplementary data 503 related to the selected transaction data 502, creates an application capable of a process equivalent to that of the main body of the smart contract acquired, and registers a building or update record of the application created, with the transfer-destination data storage unit 62. Next, it is considered a case wherein “type” of the selected transaction data 502 corresponding to vertex data 505 corresponding to a certain element included in the vertex data list is “smart contract execution”. In this case, following the contents of the selected transaction data 502, the transaction-format registration unit 61 executes an application capable of a process equivalent to that of the smart contract specified in “execution object”, and records a processing result in executing the application in the transfer-destination data storage unit 62. Further, in a case wherein a smart contract equivalent to that of the distributed ledger can be operated in the transaction-format registration unit 61, the transaction-format registration unit 61 may use the main body itself of the smart contract without converting the main body of the smart contract into an application.

### Description of Effect of Fourth Embodiment

As described above, according to the present embodiment, it is possible to perform at least any of extracting data or transferring data from not only a distributed ledger, but also a data store that is capable of at least any of registering or referring to a format of transaction data with the distributed ledger. Further, according to the present embodiment, it is possible to relatively simply transfer data that is extracted from one or more distributed ledgers and data stores to one or more other distributed ledgers and data stores by one data transfer device 1.

Further, the present embodiment is characterized by representing one or more distributed ledgers and data stores as transaction-relation data, and being able to transfer data corresponding to the transaction-relation data to one or more other distributed ledgers and data stores. By the present features, when a system using a distributed ledger as a data infrastructure and a system using a data store as a data infrastructure are integrated, it is possible to transfer data in a relatively simple manner by a person in charge of a data transfer operation by using one tool. Therefore, according to the present embodiment, it is possible to reduce human load regarding the operation to transfer data.

### Another Embodiment

It is possible to freely combine each embodiment as described above, to deform an arbitrary component of each embodiment, or to omit an arbitrary component in each embodiment.

Further, the embodiment is not limited to those described in the first through fourth embodiments, and various modifications are possible as needed. The procedures described using flowcharts, etc. may be suitably changed.

### REFERENCE SIGNS LIST

1: data transfer device; 11: data extraction unit; 111: acquisition request reception unit; 112: data acquisition unit; 113: data selection unit; 12: transfer order creation unit; 121: transaction-relation data creation unit; 122: transaction-relation data record unit; 13: data registration unit; 131: registration request reception unit; 132: data creation unit; 133: data transmission unit; 14: supplementary data management unit; 141: supplementary data reception unit; 142: supplementary data record unit; 15: ledger update monitoring unit; 16: data verification unit; 161: verification request reception unit; 162: verification data acquisition request unit; 163: verification unit; 2: management device; 21: transfer request unit; 211: acquisition request unit; 212: registration request unit; 22: supplementary data registration request unit; 23: data verification request unit: 3: transfer-source ledger network; 31: transfer-source node; 4: transfer-destination ledger network; 41: transfer-destination node; 5: transfer-source data store; 51: transaction-format reference unit; 52: transfer-source data storage unit; 6: transfer-destination data store; 61: transaction-format registration unit; 62: transfer-destination data storage unit; 501: transfer-source data acquisition request; 502: selected transaction data; 503: supplementary data; 504: transaction-relation graph; 505: vertex data; 506: edge data; 507: main key update history table: 508: smart contract update history table; 509, 509b: transfer-destination data registration request; 510: transfer data; 511: data verification request; 10: computer; 81: processor; 82: memory: 83: communication interface; 84: auxiliary storage device: 88: processing circuit; 90: data transfer system.

1. A data transfer device comprising
processing circuitry to:
acquire, based on a transfer request to transfer electronic data from a transfer-source distributed ledger to a transfer-destination distributed ledger, acquisition data including data corresponding to each of creation elements, each of the creation elements respectively created as each element of transfer data being data including one or more elements, from the transfer-source distributed ledger;
select and extract data corresponding to the creation elements from the acquisition data; and
create data to specify a transfer order to transfer the data corresponding to each of the creation elements to the transfer-destination distributed ledger, using the data corresponding to the creation elements, wherein
the transfer data is data corresponding to the transfer request, and
each of the creation elements corresponds to at least a part of the electronic data.

2. The data transfer device as defined in claim 1, wherein
when supplementary data being at least one piece of data corresponding to at least one of the data corresponding to the creation elements on a one-to-one basis exists, the supplementary data being data to support transferring the data corresponding to each of the creation elements to the transfer-destination distributed ledger, the processing circuitry creates the data to specify the transfer order using the data corresponding to the creation elements and the supplementary data.

3. The data transfer device as defined in claim 2, wherein
the processing circuitry creates, using the data corresponding to the creation elements, each of the creation elements in accordance with a format of each of the creation elements; and
transmits the data corresponding to each of the creation elements to the transfer-destination distributed ledger based on the data to specify the transfer order.

4. The data transfer device as defined in claim 3, the data transfer device being included in a data transfer system including one other data transfer device with a same function as a function the data transfer device, wherein
the processing circuitry acquires other device registration information indicating data that is received from the other data transfer device and is registered with the transfer-destination distributed ledger by the transfer-destination distributed ledger,
the processing circuitry creates each of the creation elements based on the data that is received and is registered with the transfer-destination distributed ledger by the transfer-destination distributed ledger, and the other device registration information, while the electronic data is being transferred, and
the processing circuitry transmits the data corresponding to each of the creation elements to the transfer-destination distributed ledger based on the other device registration information, and transmits, to the other data transfer device, information indicating data that is registered with the transfer-destination distributed ledger by transmitting the data corresponding to each of the creation elements to the transfer-destination distributed ledger by the processing circuitry.

5. The data transfer device as defined in claim 3, wherein
the data corresponding to the creation elements is data indicating transactions,
the processing circuitry extracts the data corresponding to the creation elements from the acquisition data as selected transaction data,
the processing circuitry creates, when the supplementary data does not exist, transaction-relation data being data to specify the transfer order based on a relation between the selected transaction data, using the selected transaction data,
and when the supplementary data exists, to create the transaction-relation data using the selected transaction data and the supplementary data, and
the processing circuitry creates, as each of the creation elements, data including data indicating the selected transaction data, or data indicating each of the selected transaction data and supplementary data corresponding to the selected transaction data, using the transaction-relation data.

6. The data transfer device as defined in claim 5, wherein
the processing circuitry creates, as the transaction-relation data, a transaction-relation graph to represent the transfer order, and a transfer condition to transfer the selected transaction data to the transfer-destination distributed ledger, in a graph structure,
the processing circuitry extracts data corresponding to each of the creation elements, which can be registered with the transfer-destination distributed ledger, as registrable data, using the graph structure of the transaction-relation graph, and
the processing circuitry transmits data including the registrable data to the transfer-destination distributed ledger.

7. The data transfer device as defined in claim 5, wherein
after at least a part of the electronic data is transferred to the transfer-destination distributed ledger,
the processing circuitry acquires from the transfer-destination distributed ledger transfer-destination acquisition data including transfer-destination data being data corresponding to each element of transfer-destination transfer data which is data corresponding to at least a part of the transfer data, based on a data verification request being a request to verify identity between the transfer-source distributed ledger and the transfer-destination distributed ledger,
the processing circuitry selects and extracts the transfer-destination data from the transfer-destination acquisition data,
the processing circuitry creates,
when supplementary data corresponding to any of the transfer-destination data does not exist, transfer-destination transaction-relation data using the transfer-destination data, and
when supplementary data corresponding to each of at least any of the transfer-destination data exists, transfer-destination transaction-relation data using the transfer-destination data, and supplementary data corresponding to the each of at least any of the transfer-destination data,
the transfer-destination transaction-relation data corresponds to relation data for comparison being at least a part of the transaction-relation data, and
the processing circuitry verifies the identity between the transfer-source distributed ledger and the transfer-destination distributed ledger, by comparing the relation data for comparison and the transfer-destination transaction-relation data.

8. The data transfer device as defined in claim 3, wherein the processing circuitry acquires data including the acquisition data from a data store that records same data as data recorded in the transfer-source distributed ledger instead of the transfer-source distributed ledger, based on the transfer request.

9. The data transfer device as defined in claim 3, wherein the processing circuitry transmits the data corresponding to each of the creation elements to a data store that is capable of processing the data corresponding to each of the creation elements instead of the transfer-destination distributed ledger.

10. A data transfer method comprising:
acquiring, based on a transfer request to transfer electronic data from a transfer-source distributed ledger to a transfer-destination distributed ledger, acquisition data including data corresponding to each of creation elements, each of the creation elements respectively created as each element of transfer data being data including one or more elements, from the transfer-source distributed ledger;
selecting and extracting data corresponding to the creation elements from the acquisition data; and
creating data to specify a transfer order to transfer the data corresponding to each of the creation elements to the transfer-destination distributed ledger, using the data corresponding to the creation elements, wherein
the transfer data is data corresponding to the transfer request, and
each of the creation elements corresponds to at least a part of the electronic data.

11. A non-transitory computer readable medium storing a data transfer program to make a data transfer device being a computer perform:
a data acquisition process to acquire, based on a transfer request to transfer electronic data from a transfer-source distributed ledger to a transfer-destination distributed ledger, acquisition data including data corresponding to each of creation elements, each of the creation elements respectively created as each element of transfer data being data including one or more elements, from the transfer-source distributed ledger;
a data selection process to select and extract data corresponding to the creation elements from the acquisition data; and
a transfer order creation process to create data to specify a transfer order to transfer the data corresponding to each of the creation elements to the transfer-destination distributed ledger, using the data corresponding to the creation elements, wherein
the transfer data is data corresponding to the transfer request, and
each of the creation elements corresponds to at least a part of the electronic data.
